(19) United States
(12) Patent Application Publication
(10) Pub. No.: US 2024/0123420 A1
(43) Pub. Date: Apr. 18, 2024

(54) FURNACE FOR ENDOTHERMIC PROCESSES

(71) Applicants: Kelly Nicholson, Buffalo, NY (US); Bo Jin, Orefield, PA (US); Monica Zanfir, Williamsville, NY (US)

(72) Inventors: Kelly Nicholson, Buffalo, NY (US); Bo Jin, Orefield, PA (US); Monica Zanfir, Williamsville, NY (US)

(21) Appl. No.: 17/964,316

(22) Filed: Oct. 12, 2022

(51) Int. Cl. B01J 19/24; C01B 3/38; C01B 3/48

(52) U.S. Cl. CPC B01J 19/2415; C01B 3/384; C01B 3/48; B01J 2219/00103; C01B 2203/0233; C01B 2203/0811; C01B 2203/0894; C01B 2203/1241

(57) ABSTRACT

The present disclosure relates to a furnace comprising:
a plurality of groupings, wherein each grouping in the furnace is adjacent to each other and separated by a gap, wherein each grouping comprises:
(a) one row of tubes and optionally additional rows of tubes comprising a plurality of tubes containing a catalyst for converting a gaseous feed, wherein each row of tubes is parallel to each other;
(b) at least two rows of burners comprising having a first and second row of outer burners and optionally additional rows of burners comprising a plurality of burners, and as described herein,
(c) wherein the plurality of burners within each grouping is configured such that the ratio of B/G is greater than 1.3 and the ratio of B/W is less than 1.3, wherein W, B and G are as defined herein.

### FIELD OF THE INVENTION

The present invention relates to the design of furnaces, e.g., top-fired reformers and bottom fired reformers, for conducting steam methane reforming processes (“SMR”) and other endothermic reactions, such as hydrocarbon feedstock cracking in externally fired reactors.

### BACKGROUND

Reforming processes such as steam or dry reforming processes are methods to produce synthesis gas, a mixture of hydrogen and carbon monoxide. In steam reforming processes, typically a natural gas or other hydrocarbon-containing feed such as refinery off-gas is passed over a heterogeneous catalyst in the presence of steam wherein the strongly endothermic reforming reactions and mildly exothermic water-gas shift reaction convert the reactants to synthesis gas. The SMR process is mainly based on the reforming reaction of light hydrocarbons, such as methane (the feed), that yields to a mixture of hydrogen (H2) and carbon monoxide (CO) in the presence of water vapor. The reaction is endothermic and slow and requires additional heat input, as well as a catalyst to occur. Usually, SMR reactor performances are limited by the heat transfer and not by the kinetics of the reactions. In industrial practice, the SMR reactor usually comprises tubes placed in a furnace, whereby the tubes are filled with catalyst—usually in the form of pellets—and fed with the process gas mixture of methane and steam. The reactor yield is then further refined downstream of the steam reformer to the desired end products.

In reformer design and operation, the burner spacing, and firing are balanced against the net endothermic reactions such that the furnace materials are kept within design temperature limitations. The main objective of the furnace design (also called firebox design) is to maximize the heat transferred from the burners to the tubes—from the burner flames and from the walls and the hot flue gas while respecting a tube maximal operating temperature constraint. For example, steam reformer firing is typically limited such that the reformer catalyst tube outside wall or “skin” temperature is maintained at or below the maximum allowable working temperature (“MAWT) for a given process stress, creep-to-rupture tube life target (typically 100,000 hours), and safety margin. The MAWT is a function of several factors, and particularly of the tube mechanical load (mainly feed gas pressure), of the mechanical properties of the alloys used for the tubes and of the desired lifetime of the tubes exposed to creep and thermal aging. Optimal utilization of the catalyst tube life occurs when all tubes in the furnace operate at the maximum allowable working temperature, maximizing heat transfer for reactions while ensuring the tubes will not require premature replacement due to overheating.

Any intensification of the heat transferred to the tubes has a direct positive impact, either by increasing the productivity or by improving the compactness of the firebox which is valuable in terms of capital expenditures. However, intensification of the heat transferred usually implies higher tube skin temperature levels that reduce tube lifetime or require more resistant alloys, which are much more expensive. Moreover, in typical furnaces, there is an inhomogeneous distribution of heat duty.

Lack of homogeneity in the heat duty distribution in the furnace will lead some of the tubes to be hotter than others; that's why temperature profiles of tubes are critical elements for the furnace design and operation. Tube temperature profiles provide decisive information when looking for a good compromise between performance and durability; a good compromise is essential.

During operation, the performance of the furnace is therefore limited by the temperature of the hottest tube; it should not be hotter than the MAWT. In the meantime, the process performance, i.e., the productivity or efficiency of conversion, depends on the average tube heat flux and temperatures. Therefore, the smaller the difference between the hottest tube temperature and the average tube temperature, the better the overall furnace performance.

Several well-proven furnace design configurations are available for conducting the SMR process as illustrated by FIG. 1, which presents top-fired (also known as down-fired), bottom-fired (also known as up-fired), side-fired, and terrace wall furnaces.

The top-fired technology is one of the most referenced designs and is proposed by several technology providers. Top-fired furnaces are typically made of a refractory lined firebox containing several rows of catalyst-containing tubes. The necessary heat for the endothermic reaction to occur is provided by roof burners placed in rows between the tubes, and by rows of additional roof burners at the furnace side, along the walls of the furnace. The combustion products out of the burners are usually blown vertically downwards, so that the upper part of the tubes face the flames. A flue gas exhaust collector is usually provided at the furnace floor level.

More specifically, in the conventional top-fired box reformer (200), shown in FIG. 2, the feed is supplied through the top part of the tubes; the synthesis gas produced, containing hydrogen and carbon monoxide as major components and residuals, is withdrawn from the bottom part of the tubes. The tubes contain catalysts and are arranged in “tube rows” (210) between rows of burners, “burner rows” (220), suspended from the furnace roof. The burners combust a mixture of air and fuel, typically natural gas, naphtha, or a mixture of plant off gases such as Hz, to produce combustion products or a “flue gas”. The burners fire downward and the flue gas flows to the flue gas collectors (240) at the bottom part of the tubes and are extracted from the furnace through openings in exhaust tunnels (230) located along the furnace floor directly beneath the burner row. The large number of tubes and burners make it necessary to add roof beams to support the structure and to ensure safety of the furnace; the support beams divide the rows in several parts (known as sections or bays). In top-fired designs, usually the reforming reactants are fed to the catalyst tubes in a co-current arrangement to better match the endothermic reaction need with incident heat flux from the burners.

The bottom-fired technology is less common in modern plants. According to the bottom-fired technology, the burners are arranged in rows on the floor of the firing area between the tube rows and fire vertically upwards. This type of reformer has an almost constant heat flux profile along the tubes.

The discussions that follow refer to top-fired furnaces. However, it is to be noted that most of the figures and explanations apply as well to bottom-fired furnaces.

In the furnaces described herein, where burners are placed in rows parallel to the tube rows, for each burner, the direction of the flame jet created by the burner is affected by the interaction with nearby coflowing jets and by the presence of walls (if any). Only the flame jets interaction within a row of burners parallel to the tube rows will be treated by this disclosure. It is to be noted that all the burners of a row parallel to the tube rows are operated at the same power or heat duty, which is not the case for the burners of a row perpendicular to the tube rows.

However, the jet flames interaction within a row of burners parallel to tube rows generates problems; there is a lack of homogeneity in the heating of tubes within the adjacent rows of tubes, as these tubes receive a variable amount of heat from the burners.

Considering the flame jet exiting a wall end burner; it behaves like a jet of fluid: the flame jet overlooking an adjacent jet flame must spray through an external stream of fluid flowing in the same direction; on the other hand, the jet flame overlooking an end wall necessarily has its local velocity near the end wall equal to zero. These dissimilar boundary conditions induce a flame jet deflection with respect to the jet axis.

In addition, a high number of tubes and/or burners in each row induce geometrical constraints in the furnace that make it necessary to add support beams to ensure safety of the furnace; these supports therefore take place in voids (or spaces or gaps) that divide the rows in several sections, typically periodically repeated. This division induces additional dissimilar boundary conditions that impact the jet flame, leading to velocity variations across the axis of the jet of the end burners closest to the supports.

In other words, the jet flames generated by different burners in a row are subjected to different influences depending on their location in the row, and consequently the tubes receive variable amounts of heat depending on their position in the row. Thus, there is an inhomogeneous heat transfer to the reforming tubes. It has been estimated that the difference between the maximum skin temperature value and the minimum skin temperature value at the same elevation within a representative bay may be as high as 30° C.

Thus, the jet flames interaction within a row of burners parallel to tube rows generates problems such as inhomogeneous heat transfer. This disclosure provides guidance for an improved furnace design that addresses the inhomogeneity of heat transfer due to burner jet interactions along a tube row. The present disclosure has found a means of solving this problem of control of heat flux homogeneity in top-fired SMR furnace, which is also applicable to bottom-fired furnaces as well.

### SUMMARY OF THE DISCLOSURE

The present disclosure is directed, inter alia, to the way that burners are distributed within the furnace to avoid the lack of homogeneity discussed above. It has been found that the arrangement of the burners pursuant to some specific ratios reduces the non-uniform heating of the reformer tubes. Accordingly, in an embodiment, the present disclosure relates to a furnace for performing an endothermic process, the furnace comprises a first set of parallel furnace walls comprising a first end wall and a second end wall disposed opposite the first end wall, and a second set of parallel furnace walls perpendicular to the first set of parallel furnace walls, where the furnace further comprises: a plurality of groupings, wherein each grouping in the furnace is adjacent to another grouping and separated by a gap, wherein each gap separating each grouping has approximately uniform dimensions, wherein each grouping comprises:
(a) at least a first row of tubes comprising a plurality of tubes containing a catalyst for converting a gaseous feed, and optionally additional rows of tubes comprising a plurality of tubes parallel to the first row of tubes in each grouping and containing a catalyst for converting said gaseous feed;
(b) at least two rows of burners inside each grouping comprising a plurality of burners mounted in the at least two rows of burners, said at least two rows of burners having a first row of outer burners and a second row of outer burners and optionally additional rows of inner burners comprising a plurality of burners, wherein each row of burners is parallel to each other, and wherein each row of burners is parallel to the first row of tubes and any additional row or rows of tubes present, wherein each row of tubes and each row of burners are parallel to the first set of parallel furnace walls and perpendicular to the second set of parallel furnace walls, such that the number of rows of tubes present is one less than the number of rows of burners present, wherein each row of tubes is adjacent to two rows of burners and wherein the first row of outer burners is adjacent to the first end wall and adjacent to the first row of tubes, and the second row of outer burners is adjacent to the second end wall, and to a last row of tubes, and each optionally inner row of burners present is adjacent to two rows of tubes; provided that when there is only one row of tubes, the last row of tubes is the same as the first row of tubes so that the last row of outer burners is adjacent to the second end wall and to the first row of tubes;
(c) wherein the plurality of burners in each row within each grouping of the furnace are configured such that the ratio of B/G is greater than 1.3 and the ratio of B/W is less than 1.3, wherein B is the distance between adjacent burner centerlines in the rows of burners within each grouping, W is the distance between the furnace wall that is perpendicular to the rows of burners and the centerline of the adjacent burner in the rows of burners, and G is one half of the distance between burner centerlines in the rows of burners in adjacent groupings, and wherein each row of tubes is parallel to each row of burners in said grouping, wherein the plurality of groupings comprises a first and last grouping and each row of burners and each row of tubes in the first and last grouping are ended by the second set of parallel walls which are perpendicular to each row of tubes and each row of burners in the first and last grouping.

In another embodiment, the present disclosure relates to a furnace for performing an endothermic process, the furnace comprises a first set of parallel furnace walls comprising a first end wall and a second end wall disposed opposite the first end wall, and a second set of parallel furnace walls perpendicular to the first set of parallel furnace walls, wherein the furnace further comprises:
(a) at least a first row of tubes inside the furnace comprising a plurality of tubes containing a catalyst for converting a gaseous feed, and optionally additional rows of tubes comprising a plurality of tubes parallel to the first and last row of tubes in said furnace and containing a catalyst for converting said gaseous feed,
(b) at least two rows of burners inside the furnace comprising a plurality of burners mounted in the at least two rows of burners, said at least two rows of burners having a first row of outer burners and a second row of outer burners and optionally additional rows of inner burners comprising a plurality of burners, wherein each row of burners is parallel to each other, and wherein each row of burners is parallel to the first row of tubes and parallel any additional row or rows of tubes present, wherein each row of tubes and each row of burners are parallel to the first set of parallel furnace walls and perpendicular to the second set of parallel furnace walls, such that the number of rows of tubes present is one less than the number of rows of burners present and the first row of burners is adjacent to the first end wall and adjacent to the first row of tubes, and the last row of outer burners is adjacent to the second end wall, and to a last row of tubes and each optionally inner row of burners present is adjacent to two rows of tubes, but wherein there is only one row of tubes, the last row of tubes is the same as the first row of tubes so that the last row of outer burners is adjacent to the second end wall and to the first row of tubes;
(c) wherein each row of burners and each row of tubes in the furnace are ended by the second set of parallel walls which are perpendicular to each row of tubes and each row of burners, wherein the plurality of burners within the furnace are configured such that the ratio of B/W is less than 1.3, wherein B is the distance between adjacent burner centerlines in the rows of burners within the furnace, W is the distance between the furnace wall that is perpendicular to the rows of burners and the centerline of the adjacent burner in the rows of burners, and wherein each row of tubes is parallel to each row of burners in said furnace, wherein each row of tubes and each row of burners are ended by the second set of parallel walls which are perpendicular to each row of tubes and each row of burners in the furnace.

In another embodiment, the present disclosure relates to a furnace for performing an endothermic process, the furnace comprises a first set of parallel furnace walls comprising a first end wall and a second end wall disposed opposite the first end wall, and a second set of parallel furnace walls perpendicular to the first set of parallel furnace walls, where the furnace further comprises: a plurality of groupings having a first and last grouping, wherein each grouping in the furnace is adjacent to another grouping and separated by a gap, wherein each grouping comprises:
(a) a plurality of rows of tubes containing a catalyst for converting a gaseous feed wherein the tubes are positioned in a plurality of rows inside the grouping, wherein the plurality of rows of tubes comprises a first row of tubes, a last row of tubes and optionally one or more inner rows of tubes disposed between the first row of tubes and the last row of tubes and wherein each row of tubes is parallel to one another;
(b) a plurality of burners in each grouping mounted in rows between each row of tubes and between the first set of furnace walls comprising a first row of outer burners and a second row of outer burners and one or more rows of inner burners, each row comprising a plurality of burners, wherein each row of burners is parallel to one another and wherein the first set of furnace walls are parallel to the rows of burners and tubes in each grouping and the second set of parallel furnace walls are perpendicular to the rows of burners and tubes in each grouping, such that the number of rows of tubes present is one less than the number of rows of burners present, wherein each row of tubes is adjacent to two rows of burners and wherein the first row of outer burners is adjacent to the first end wall and adjacent to the first row of tubes, and the second row of outer burners is adjacent to the second end wall, and to the last row of tubes and each inner row of burners present is adjacent to two rows of tubes;
(c) wherein the plurality of burners within each grouping of the furnace are configured such that the ratio of B/G is greater than 1.3 and the ratio of B/W is less than 1.3, wherein B is the distance between adjacent burner centerlines in the rows of burners within each grouping, W is the distance between the furnace wall that is perpendicular to the rows of burners and the centerline of the adjacent burner in the row of burners, and G is one half of the distance between burner centerlines in the row of burners in adjacent groupings, and wherein each row of tubes is parallel to each row of burners in said grouping, wherein the plurality of groupings comprises a first and last grouping and each row of burners and each row of tubes in the first and last grouping are ended by the second set of parallel walls which are perpendicular to each row of tubes and each row of burners in the first and last grouping.

Another embodiment relates to a furnace for performing an endothermic process. The furnace comprises a first set of parallel furnace walls comprising a first end wall and a second end wall disposed opposite the first end wall, and a second set of parallel furnace walls perpendicular to the first set of parallel furnace walls, and wherein the furnace further comprises:
(a) a plurality of rows of tubes in the furnace containing a catalyst for converting a gaseous feed wherein the tubes are positioned in a plurality of rows inside the furnace, wherein the plurality of rows of tubes comprises a first row of tubes, a last row of tubes and optionally one or more inner rows of tubes disposed between the first row of tubes and the last row of tubes and wherein each row of tubes is parallel to one another;
(b) a plurality of burners in the furnace mounted in rows between each row of tubes and between the first set of furnace walls comprising a first row of outer burners and a second row of outer burners and one or more rows of inner burners, each row of burners comprising a plurality of burners, wherein each row of burners is parallel to one another and wherein the first set of furnace walls are parallel to the rows of burners and tubes in the furnace and the second set of parallel furnace walls are perpendicular to the rows of burners and tubes in the furnace, such that the number of rows of tubes present is one less than the number of rows of burners present, wherein each row of tubes is adjacent to two rows of burners and wherein the first row of outer burners is adjacent to the first end wall and to the first row of tubes, and the second row of outer burners is adjacent to the second end wall and to the last row of tubes and each inner row of burners present is adjacent to two rows of tubes; and
(c) wherein the rows of burners and the rows of tubes are ended by the second set of furnace walls perpendicular to the row of burners and tubes, wherein the plurality of burners within the furnace are configured such that the ratio of B/W is less than 1.3 and all of the burners are substantially uniformly spaced apart in each row; wherein B is the distance between adjacent burner centerlines in the row of burners within the furnace; W is the distance between the furnace wall that is perpendicular to the row of burners and the centerline of the adjacent burner in the row of burners, and wherein each row of tubes is parallel with each row of burners, and wherein each row of tubes and each row of burners are ended by the second set of parallel walls which are perpendicular to each row of tubes and each row of burners in the furnace.

In an embodiment, the endothermic process is the steam methane reforming process or hydrocarbon feedstock cracking.

Another embodiment of the present process relates to an endothermic process to be performed in a furnace, the process comprising:
(a) providing the furnace as described above;
(b) introducing a gaseous feed and steam into said furnace under conditions effective for converting the gaseous feed and steam into products; and
(c) discharging the products.

In an embodiment, the endothermic process is the steam methane reforming process, e.g., a carbon dioxide methane dry reforming furnace or hydrocarbon feedstock cracking.

### BRIEF DESCRIPTION OF THE DRAWINGS

Objects, features, and advantages of the present disclosure will become more clearly apparent when the following description is taken in conjunction with the accompanying drawings, wherein like reference numerals denote like parts and in which:

FIG. 1 shows the burner configuration for typical furnace designs.

FIG. 2 shows the arrangement of burner rows, tunnels, and tube rows in a top-fired box reformer. In this figure, the x-axis is oriented along the horizontal axis, the z-axis is oriented along the vertical axis; and the y-axis is oriented along a third axis to show depth.

FIG. 3 is a top view of a top-fired box reformer of an embodiment of the present disclosure with alternating burner rows and tube rows.

FIG. 4 depicts the temperature field obtained via CFD simulation of a single burner row arranged into three groups of six burners each, where the B/W=1.26 and B/G=1.8.

FIG. 5 depicts the temperature field obtained via CFD simulation of a single burner row arranged into three groups of six burners each, where the B/W=1.18 and B/G=1.1.4.

FIG. 6 is a top view of a top-fired box reformer of an embodiment of the present disclosure with two rows of burners and one row of tubes.

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing the exemplary embodiments of the invention, it being understood that various changes may be made in the function and arrangement of elements without departing from the scope of the invention as defined by the claims.

Those of skill in the art also understand that the terminology used for describing embodiments does not limit the scope or breadth of the disclosure. In interpreting the specification and appended claims, all terms should be interpreted in the broadest possible manner consistent with the context of each term. All technical and scientific terms used in the specification and appended claims have the same meaning as commonly understood by one of ordinary skill in the art to which this invention belongs, unless defined otherwise.

The articles “a” and “an”, as used herein, mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or specified features and may have a singular or plural connotation depending upon the context in which it is used.

The term “and/or” placed between a first entity and a second entity includes any of the meanings of (1) only the first entity, (2) only the second entity, and (3) the first entity and the second entity. The term “and/or” placed between the last two entities of a list of 3 or more entities means at least one of the entities in the list including any specific combination of entities in this list. For example, “A, B and/or C” has the same meaning as “A and/or B and/or C” and comprises the following combinations of A, B and C: (1) only A, (2) only B, (3) only C, (4) A and B and not C, (5) A and C and not B, (6) B and C and not A, and (7) A and B and C.

As used herein, the term “or” is not meant to be exclusive; rather the term is inclusive, meaning either or both.

References in the specification to “one embodiment”, “an embodiment”, “another embodiment, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The terms “about,” “approximately” or any synonym thereto, as used in this specification and appended claims, refers to plus or minus 5% of the value given.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

The term “consisting of” and its derivatives as used herein are intended to be closed terms that specify the presence of the stated features, elements, components, groups or groupings, integers, and/or steps and also exclude the presence of other unstated features, elements, components, groups or groupings, integers, and/or steps.

The term “consisting essentially of”, as used herein, is intended to specify the presence of the stated features, elements, components, groups or groupings, integers, and/or steps as well as those that do not materially affect the basic and novel characteristic(s) of these features, elements, components, groups or groupings, integers, and/or steps. A subset of “consisting essentially of” is “consisting of,” which is defined hereinabove. Thus, it is understood whenever the term “consisting essentially of” is used, it may be replaced with “consisting of” and these embodiments are contemplated within the present disclosure.

“Providing” in a claim is defined to mean furnishing, supplying, making available, or preparing something. The step may be performed by any actor in the absence of express language in the claim to the contrary.

Further, as used herein, the singular denotes the plural and vice versa.

As defined herein, there are various ranges of numbers or ratios provided herein. It is to be understood that the ranges include not only the endpoints (plus or minus 5% when modified by the term about or approximately or words synonymous thereto), but also all of the integral numbers and fractions therebetween. Thus, for example, if the range is defined as ranging from 5 to 10, it is understood that the values include the endpoints 5 and 10, but also all the integers and fractional numbers and real numbers therebetween and each one of those values are described herein, for purposes of the teaching of the disclosure described herein. Furthermore, unless indicated to the contrary, if the disclosure refers to a component being present in less than certain %, it is understood that the component is present in an amount ranging from 0%, but excluding 0%, to that certain %, unless indicated to the contrary. Thus, for example, if a component is being described as being present in less than 3 wt %, it is understood that it is meant that the component is present in an amount ranging from 0% to 3 wt %, exclusive. If a component is not present, the application will so state using terms that signify that a particular component is absent, such as “absent of such component,” “free of such component” or any like term.

The term “plurality” signifies more than 1. In other words, it means at least two.

As used herein, the term “substantially uniform” is used to denote that a first object is identical to a second object without more than 5% variation in detail. For example, if two burners are substantially uniform in dimensions or size, this implies that the dimension or size of the two burners are similar, being no more than 5% different, relative to each other.

As used herein, the term that the “groupings are substantially identical” or the “groupings are substantially the same” or “each grouping are substantially the same” or “each grouping in the furnace are substantially the same” or any like term is meant to denote that the arrangement of burners or tubes, depending upon the context, with respect to one grouping of the furnace is identical with another grouping of the furnace, with no more than 5% of the burners or tubes, respectively, in one grouping of the furnace being different from another grouping in the furnace or that the number of burners or tubes in one grouping does not differ from the number of burners or tubes in another grouping does not differ than more than 5%. Thus, this difference may be in the number of burners or tubes in the grouping or in the size of the burners and the like.

In the specification, direction will be described as being parallel to the row of tubes or perpendicular to the row of tubes in the furnace or as being parallel to a first set of furnace walls or perpendicular to a second set of furnace walls, or like expressions.

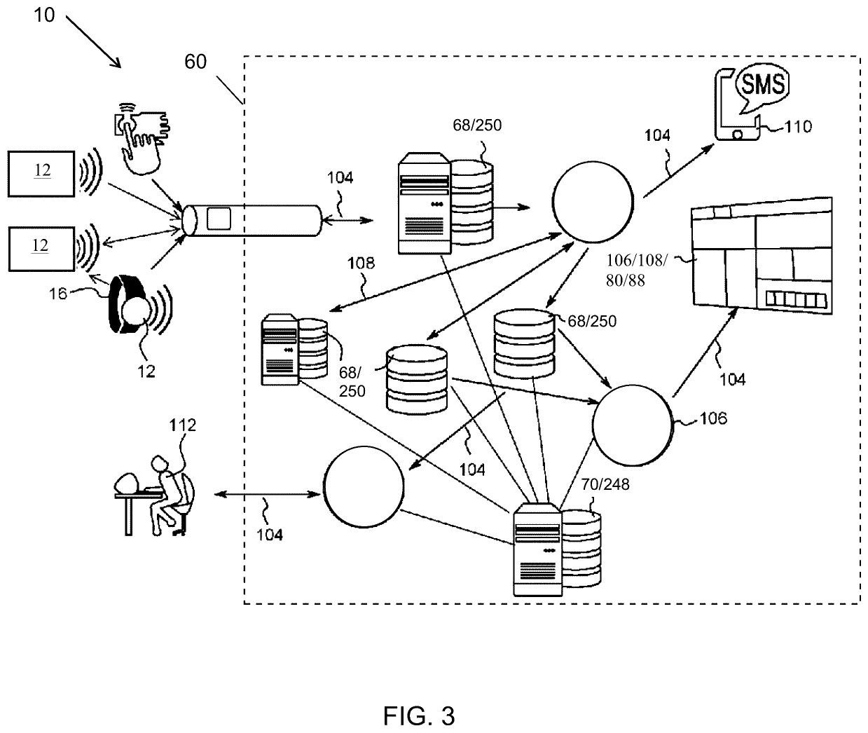

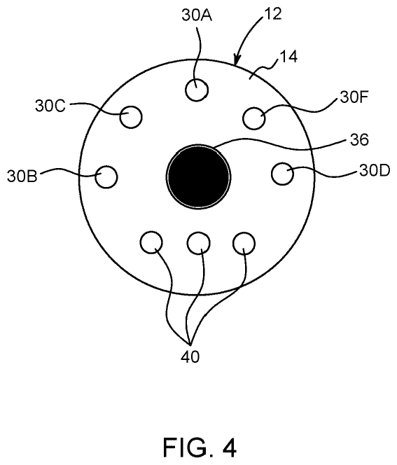

As used herein, the term “row of tubes” refers to a line of tubes wherein the tubes are in a linear line and adjacent to each other without being separated from one another by a row of burners, whereby each row of tubes is parallel to another row of tubes and to each row of burners in the furnace. The row of tubes and burners may be parallel to the horizontal axis of the furnace (x-axis) or parallel to the vertical axis (y-axis) of the furnace. Said a different way, the rows of tubes may be parallel to a first set of furnace walls or perpendicular to a second set of furnace walls, as defined herein. For example, in FIG. 3, the rows of tubes and burners depicted therein are parallel to the y-axis and perpendicular to the x-axis. The term “tube row,” as used herein, is synonymous with the term “row of tubes.”

The term “row of burners,” as used herein, refers to a set of burners in a linear line and adjacent to one another in the linear line without being separated from one another by a row of tubes, whereby each row of burners is parallel to another row of burners and to each row of tubes in the furnace. The row of burners may be parallel to the horizontal axis of the furnace (x-axis) or parallel to the vertical axis (y-axis) of the furnace. Said a different way, the rows of burners may be parallel to a first set of furnace walls or perpendicular to a second set of furnace walls, as defined herein. For example, in FIG. 3, the row of burners (321) depicted therein is parallel to the y-axis and perpendicular to the x-axis. The term “burner row” is synonymous with “row of burners.”

In the description herein below, the expression “row of burners” is to be understood as “row of burners parallel to the tube rows”; rows of burners that are perpendicular to the tube rows will be explicitly identified, when necessary, as “line of burners perpendicular to the tube rows”.

The term “row of outer burners” refers to the burners in a row that are adjacent to the set of furnace walls that are parallel thereto. The term “inner row of burners” refers to the burners in a row that are adjacent to the two rows of tubes that are parallel thereto. It is understood that the inner row of burners is not adjacent to the set of parallel walls that are parallel thereto.

The term “outer row of tubes” refers to the first row and last row of tubes which are parallel to the row of burners and are adjacent on one side to the row of outer burners.

The term “inner row of tubes” refers to the row of tubes that are disposed between the first row of tubes and the last row of tubes and adjacent on each side to the inner rows of burners. It is understood that the inner row of tubes is not adjacent to the outer row of burners. On the other hand, the term “outer row of tubes” refers to the first and last row of tubes.

In the furnaces concerned by the invention where burners are placed in rows parallel to the tube rows, for each burner, the direction of the flame jet created by the burner is affected by the interaction with nearby coflowing jets and by the presence of walls (if any).

Hereafter, only the flame jets interaction within a row of burners parallel to the tube rows will be treated by this disclosure. It is to be noted that all the burners of a row parallel to the tube rows are, in an embodiment, operated at the same power, which is not the case for the burners of a row perpendicular to the tube rows.

As used herein, the term “outer end walls” refers to the longer set of parallel walls, and the term “end walls” refers to the shorter set of parallel walls, wherein the set of outer end walls are perpendicular to the set of inner end walls.

The terms “optional” or “optionally”, as used herein, refers to a feature or structure that may be present, and that the description includes instances in which the particular feature or structure is present and instances in which the particular feature or structure is absent.

As used herein, the terms “grouping(s)” and “group(s)” are synonymous.

As used herein, the term “feed” refers to a gaseous hydrocarbon that is fed into the furnace. The term “gaseous hydrocarbon” refers to a compound comprised of only carbon and hydrogen atoms having up to one to ten carbon atoms that is flammable in the gaseous state. Examples include natural gas, methane, ethane, propane, butane, naphtha, and the like.

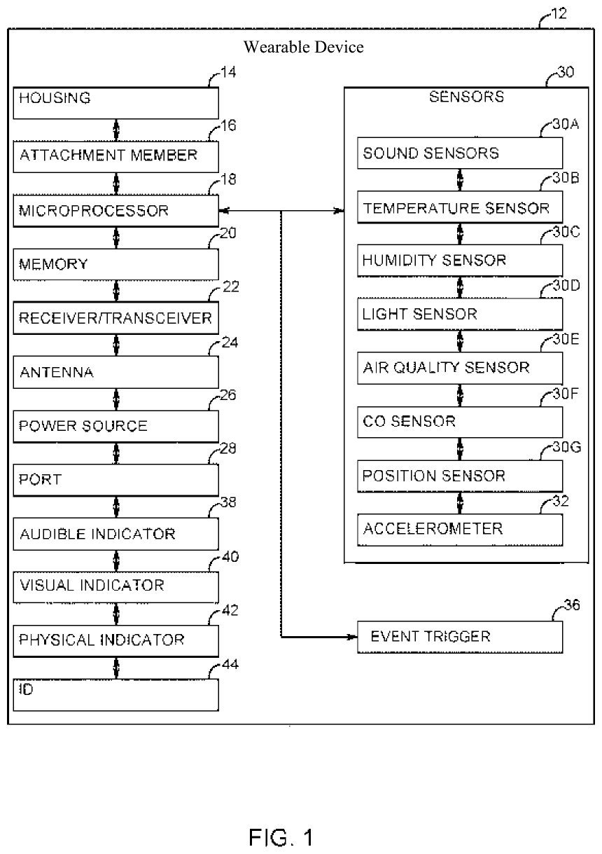

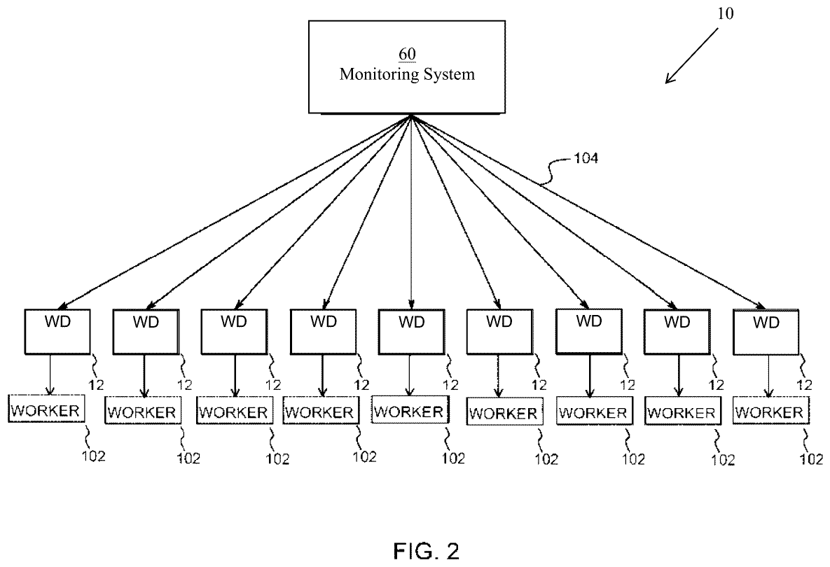

As stated above, the present disclosure aims at providing an improved design of top-fired or bottom-fired type furnaces, which are illustrated in FIG. 1, for performing an endothermic process; the objective is to mitigate the temperature variations along a row of burners parallel to the rows of tubes having the same power thanks to an improved repartition of the burners along the row. In order to identify and propose the arrangement of burners in a row, numerical simulations have been performed for different arrangements of the burners for several SMR plants. The numerical simulations are made on representative rows of burners and burner groupings in top-fired SMRs using a 3-D Computational Fluid Dynamic (CFD) solver intended for calculation of the heat transfer between the combustion chamber and the tubular catalytic reactors and the flame jet flow interactions.

Reference is made to FIG. 3 for a better understanding of the present disclosure. However, it is to be understood that FIG. 3 is exemplary of the embodiments of the present disclosure. It presents a top view of a top-fired box reformer (300). The furnace can be any shape, but in an embodiment, it is rectangular or square in shape. The furnace has two sets of parallel walls, one set of parallel walls consists of a top wall (330) and a bottom wall (340) along the x-axis. Unless indicated to the contrary, these two walls will be designated herein as end walls. —In addition, the furnace has another set of parallel walls that consists of two side walls (350, 360), along the y-axis, sometimes referred to as “outer row walls”. Each set of furnace end walls (330, 340) are parallel to one another and perpendicular to the set of furnace outer walls. (350, 360). Moreover, each set of outer walls (350, 360) are parallel to each other and perpendicular to the set of end walls (330, 340). All the interior walls of the furnace are exposed to flue gases.

The furnace is comprised of tubes (301) and burners (302) arranged in rows. The rows of tubes are comprised of the outer row of tubes (315, 317), and inner row of tubes (310), wherein each tube is adjacent to another in a row of tubes. The rows of burners are comprised of the outer row of burners (312, 316) and an inner row of burners (313, 314), and each burner is adjacent to another in a row of burners and each burner row, and each tube row is parallel. The plurality of tubes is positioned in a plurality of rows inside the furnace, wherein the plurality of rows of tubes comprises a first row of tubes (317), a last row of tubes (318) and one or more inner row of tubes (319) disposed between the first row of tubes (317) and the last row of tubes (318). The tubes contain catalysts for converting a gaseous feed. In the embodiment depicted in FIG. 3, the plurality of burners are positioned in a plurality of rows inside the furnace, wherein each row of burners is parallel with the row of tubes, wherein the plurality of rows of burners comprises a first row of burners (312), a last row of burners (316) and one or more inner rows of burners (313, 314) disposed between the first row of burners (312) and the last row of burners (316) and wherein the first row of burners (312) is adjacent to one of the parallel furnace wall in a set (350), and the last row of burners (316) is adjacent to the other parallel furnace wall in the same set (360). Moreover, as shown in FIG. 3, each row of burners alternates with each row of tubes. In other words, a first row of burners (312) is adjacent and parallel to a first row of tubes (317) which, in turn, is adjacent to a second row of burners (313). If there is more than one row of tubes and more than two rows of burners, this pattern continues with each additional row of tubes being parallel and adjacent to each row of burners such that the first row of burners (312) is adjacent to one of the parallel furnace walls (350), and the last row of burners (316) is adjacent to the other parallel furnace wall (360) in the same set. Thus, each row of tubes is adjacent to two parallel rows of burners. If there are more than two rows of burners, the inner row(s) of burners (313, 314) is adjacent to two parallel rows of tubes. As described, the present disclosure contemplates that the number of rows of burners is one more than the number of rows of tubes.

In FIG. 3, the burner rows (312, 313, 314, 316)) and tube rows (317, 318, 319)) are oriented along the y-axis. In FIG. 3, in the line of burners perpendicular to the row of tubes (i.e., along the x-axis), each burner is separated from another burner by tubes interspaced therebetween, so that each tube in the line perpendicular to the row of burners is adjacent to two burners. Alternatively, in another embodiment, not shown, the burner and tube rows are oriented along the x-axis, wherein each tube is adjacent to another tube in the row of tubes and each burner is adjacent to another burner in the row of burners and in the line of burners perpendicular to the line of tubes (i.e., along the y-axis), each burner is separated from one another burner by a tube interspaced therebetween, so that each tube is adjacent to a burner. Both configurations are contemplated by the present disclosure.

The plurality of rows of burners and plurality of rows of tubes are parallel to each other and are located between the walls of the furnace. In FIG. 3, the row of burners extends from furnace wall (330) to furnace wall (340). In FIG. 3, the first row (312) and last row of burners (316) are parallel to furnace walls (350, 360). The first burner in each row and the last burner in each row are adjacent on one side to furnace wall (330) and on the other side to furnace wall (340), respectively, wherein furnace walls (330) and furnace wall (340) are parallel to one another and perpendicular to furnace walls (350, 360).

The reformer mechanical structure separates burner rows and tube rows into groupings. The burners are typically arranged linearly in both the vertical and horizontal directions. In FIG. 3, the rows of tubes (317, 318, 319) and the rows of burners (312, 313, 314, 316)) are parallel to the vertical axis (y-axis). Distances between burners and obstacles like walls or tubes affects the jet flame behavior and heating uniformity, defined as the same incident heat flux as a function of tube length from tube to tube. In FIG. 3, each of the reformer burner rows (312, 313, 314, 316) has four burners in each grouping, and there are three groupings of four burners in a row along the y-axis so that each burner row contains 12 burners. A grouping, as used herein, is the total number of tubes and total number of burners within a row adjacent to each other with substantially the same spacing and separated by a gap, as defined hereinbelow, with a larger spacing. In other words, in FIG. 3, there are 4 burners repeated three times separated by a burner group division line or gap (391) within a burner row. Likewise, within the tube row there are 16 tubes repeated three times separated by a gap (391). All of the tubes and burners that are present in the portion of the burner between the set of walls (350, 360) that are parallel to the burner rows (312, 313, 314, 316) and tubes (317, 318, 319) that are located between a gap (391) and the set of walls (330, 340) perpendicular to the burner rows (312, 313, 314, 316) and tube rows (317, 318, 319) or separated by two gaps is a grouping. Thus, in FIG. 3, three groupings are depicted within the furnace.

In an embodiment, the various gaps in the furnace separating each grouping have unequal dimensions, wherein some are larger, while others are smaller. In an embodiment, the gaps separating each grouping have approximately uniform dimensions.

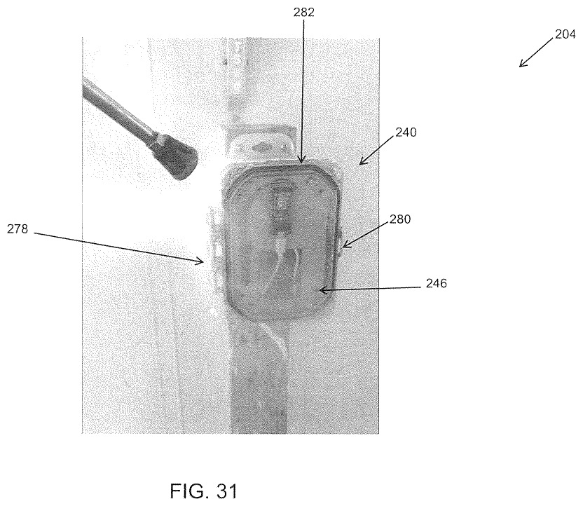

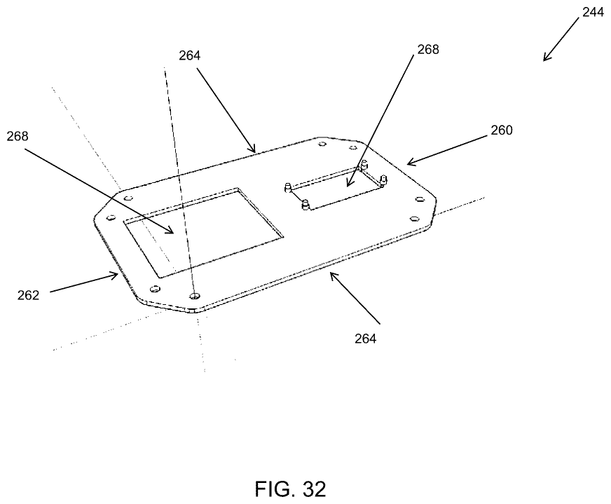

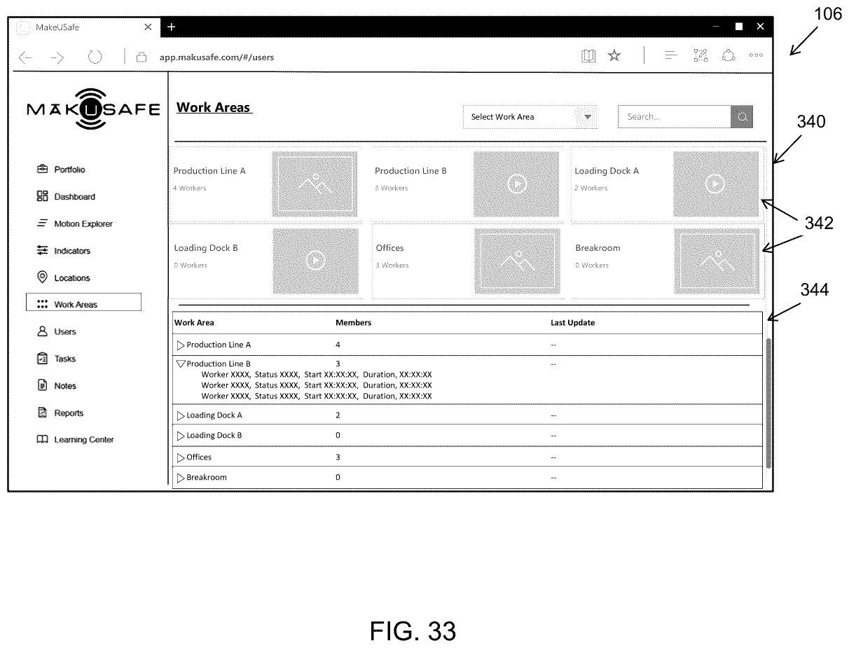

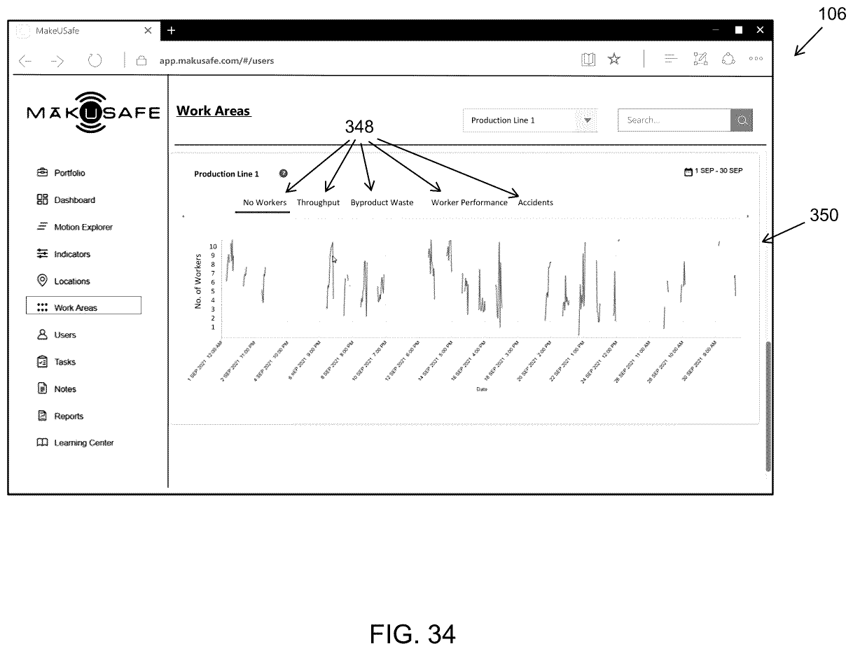

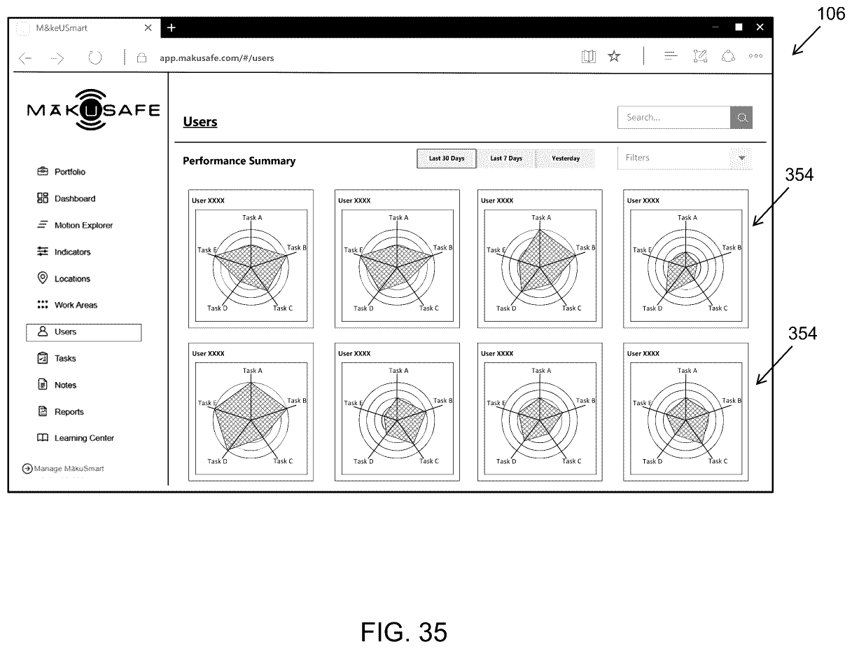

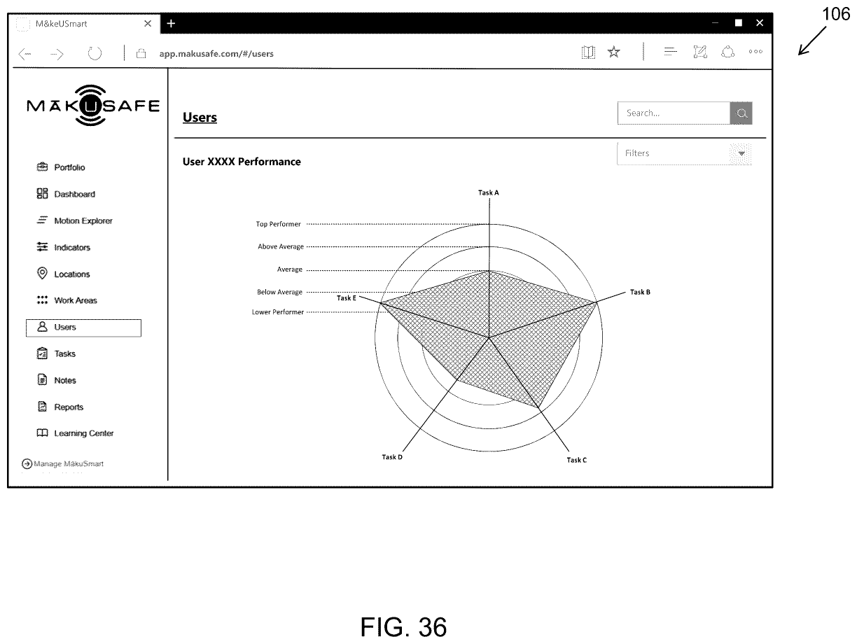

In another embodiment, the furnace comprises only one row of tubes and two rows of burners. This embodiment is illustrated in FIG. 6, which is a top view of a top-fired box reformer. The embodiment in FIG. 6 is subgeneric to the embodiment in FIG. 3 and differs from the embodiment in FIG. 3 in that there is only one row of tubes and two rows of burners. Thus, there are no inner rows of burners in the embodiment depicted in FIG. 6, but only outer rows of burners (312, 316). Further, there are no plurality of rows of tubes, as there is only one row of tubes (317). In this embodiment, the row of tubes (317) is both the first row of tubes and the last row of tubes.

However, all of the other descriptions above, regarding the present disclosure, for which the embodiment in FIG. 3 is representative, are applicable to the embodiment depicted in FIG. 6 and are incorporated herein by reference. The furnace can be any shape, but in an embodiment, it is rectangular or square in shape. The furnace has two sets of parallel walls, one set of parallel walls consists of a top wall (330) and a bottom wall (340) along the x-axis, which in FIG. 6 are the shorter set of walls. In addition, the furnace has another set of parallel walls that consists of two side walls (350, 360), along the y-axis, sometimes referred to as “outer row walls”. This set of two side walls (350, 360) are depicted in FIG. 6 as the longer set of side walls. Each set of furnace end walls (330, 340) are parallel to one another and perpendicular to the set of furnace outer walls (350, 360). Moreover, each set of outer walls (350, 360) are parallel to each other and perpendicular to the set of end walls (330, 340). All the interior walls of the furnace are exposed to flue gases

Just as in FIG. 3, the furnace is comprised of tubes and burners, except in FIG. 6, the plurality of burners is arranged in two rows (312, 316) and the plurality of tubes is present in one row (317), wherein each burner in the row of burners comprised of a plurality of burners is adjacent to the outer end walls (350, 360) and wherein each tube in the one row of tubes comprised of a plurality of tubes is adjacent to the two rows of burners (312, 316) comprised of a plurality of burners. The tubes contain catalysts for converting a gaseous feed. In the embodiment depicted in FIG. 6, the plurality of burners is positioned in two rows (312, 316) inside the furnace, wherein each row of burners is parallel with the one row of tubes (317), wherein the plurality of rows of burners comprises a first row of burners (312) and a last row of burners (316) wherein the first row of burners is adjacent to one of the parallel furnace wall in a set (360), and the last row of burners is adjacent to the other parallel furnace wall in the same set (350). In FIG. 6, the one row of tubes (317) is adjacent to two parallel rows of burners (312, 316). As described, the present disclosure contemplates that the number of rows of burners is one more than the number of rows of tubes.

In FIG. 6, the two burner rows (312, 316) and one tube row (317) are oriented along the y-axis. In FIG. 6, in the line of burners perpendicular to the row of tubes (i.e., along the x-axis), and each burner is separated from another burner by tubes interspaced therebetween, so that each tube in the line perpendicular to the row of burners is adjacent to two burners. Alternatively, in another embodiment, not shown, the burner rows and tube row are oriented along the x-axis, wherein each tube is adjacent to another tube in the row of tubes, and each burner is adjacent to another burner in the row of burners. In the line of burners perpendicular to the line of tubes (i.e., along the y-axis), each burner is separated from one another burner by a tube interspaced therebetween, so that each tube is adjacent to a burner. Both configurations are contemplated by the present disclosure.

The plurality of rows of burners and the one row of tubes in FIG. 6 are parallel to each other and are located between the walls of the furnace. In FIG. 6, the rows of burners extend from furnace wall (330) to furnace wall (340). In FIG. 6, the first row and last row of burners are parallel to furnace walls (350, 360). The first burner in each row and the last burner in each row are adjacent on one side to furnace wall (330) and on the other side to furnace wall (340), respectively, wherein furnace walls (330) and furnace wall (340) are parallel to one another and perpendicular to furnace walls (350, 360).

The reformer mechanical structure separates burner rows and tube rows into groupings. The burners are typically arranged linearly in both the vertical and horizontal directions. In FIG. 6, the row of tubes (317) and the rows of burners (312, 316) are parallel to the vertical axis (y-axis). Distances between burners and obstacles like walls or tubes affects the jet flame behavior and heating uniformity, defined as the same incident heat flux as a function of tube length from tube to tube. The reformer mechanical structure of the furnace separates burner rows and tube rows into groupings, In FIG. 6, as in FIG. 3, each of the reformer burner rows has four burners in each grouping separated by a gap (391), and there are three groupings of four burners in a row along the y-axis so that each burner row contains 12 burners. Likewise, within the tube row (317), there is a grouping of 16 tubes repeated three times separated by a gap (391). All of the tubes and burners that are present in the portion of the burner between the set of walls (350, 360) that are parallel to the burner rows (312, 314) and one row of tubes (317), that are located between a gap (391) and the set of walls (330, 340) perpendicular to the burner rows (312, 314) and the one tube row (317) or separated by two gaps is a grouping. Thus, in FIG. 3, three groupings are depicted within the furnace.

Thus, in FIG. 6, three groupings are depicted within the furnace.

As indicated earlier, each grouping in FIGS. 3 and 6 is separated from another grouping by the burner grouping division line or gap (391) The groupings end either by a wall or by a plane separating two adjacent groupings. The division between each grouping is delineated by the burner group division plane (391), i.e., the gap plane. The distance of the nearest burner in one grouping to this burner group division line (391) is equal to the distance of the nearest burner in the adjacent burner grouping to this burner group division line (391). This gap (391) separating each grouping has approximately uniform dimensions within a row. In an embodiment, each grouping in the furnace is substantially identical.

The distance between adjacent burner centerlines in the row of burners within a grouping is denoted “B.” The distance between adjacent burner centerlines for two adjacent burner groupings (i.e., across the gap) along the axis perpendicular to the row of burners is denoted “2G”, where “G” is then half of the distance between burner centerlines in adjacent groupings. “W” is the distance between the reformer box refractory wall perpendicular to the row of tubes and the centerline of the adjacent burner. In FIGS. 3 and 6, the distance between adjacent burners centerlines along the vertical axis within a grouping is denoted “B” (370). The distance between adjacent burner centerlines for two adjacent burner groupings (i.e., across the gap) is denoted “2G” (390), where “G” is then half of the distance between burner centerlines in adjacent groupings. “W” is the distance between the reformer box refractory wall along the vertical axis and the centerline of the adjacent burner (380).

As stated above, the disclosure aims at controlling the heat flux inhomogeneities in a representative grouping to consequently control the heat flux all along the row, and finally to improve the heat flux control in the whole furnace. To achieve this result, the invention aims at limiting the flame jets merging thanks to an improved burners arrangement design along rows of burners of same power.

The ratios of B/W and B/G define the distribution of burners within a burner row, which has an impact on the uniform heating of the tubes. Given that the ratios of B/W and B/G for a given furnace define the distribution of burners and burner jets within that furnace, it has been found that maintaining B/W<1.3<B/G will prevent the substantial merging of burner jets within burner groupings, thus providing a more uniform heating of the reformer tubes from a single burner row. Put another way, B/G is greater than 1.3, but the ratio of B/W is not greater than 1.3.

The descriptions for the various embodiments of the present disclosure are applicable to each row containing a plurality of burners in each row in each grouping. and a plurality of tubes in each row in each grouping. However, depending upon the number of tubes and burners in each row, it may be necessary to add support beams to ensure safety of the furnace; said supports divide the rows in several parts (also known as sections or groupings or bays).

Further, the number of burners in a row along the x-axis in a grouping may or may not be equal to the number of burners (in a line of burners perpendicular to the tube rows along the y-axis in the same grouping. In an embodiment in the present disclosure, regardless of the number of rows of burners or tubes, the number of burners in each row in each of the groupings in the furnace is the same, and the number of burners in each line of burners perpendicular to tube rows, which in this case, is parallel to the y-axis, in each grouping in the furnace is the same. Moreover, in an embodiment of the present disclosure, the burners used in each of the rows in each grouping is substantially the same, e.g., they are substantially the same size and are operated at the same power, and the number of burners in each row in one grouping is the same as the number of burners in another row of burners parallel thereto. However, in each grouping, the number of burners in each row and the number of burners in any line of burners perpendicular thereto and separated by obstacles, such as tubes, may or may not be the same.

In the reformer burner rows in FIGS. 3 and 6, the burners in the rows are substantially uniformly distributed within each burner grouping. In an embodiment of the present disclosure, the number of burners in a row are substantially the same. In an embodiment of the present disclosure, the distance between burners in a row in each grouping of the furnace is approximately the same.

In FIG. 3, the outer rows of burners (312, 316) may or may not have a different burner spacing than the inner rows of burners (313, 314). In an embodiment, the outer rows of burners (312, 316) have the same spacing between burners as the inner rows of burners (313, 314). However, as described herein, the present disclosure for all of the embodiments herein having a gap focuses on the B/W and B/G spacings within a row, regardless of whether the burner rows are uniformly distributed or not or whether the burners are different or the same. In an embodiment, of the present disclosure, the size of the burners in a row are approximately the same, although the size of burners in different rows may or may not be the same. In an embodiment, the size of the burners in each row in a grouping is approximately the same, while in another embodiment, the size of the burners within each grouping in the furnace is approximately the same. Moreover, in another embodiment, the size of the burners within each row in each grouping is approximately the same as the size of the burners in another grouping of the furnace. Finally, the size of all of the burners in the furnace is approximately the same.

Thus, the distance of a burner at the end of a burner row to an end wall (adjacent to an end tube, parallel to the x-axis) need not be the same as the distance of a burner to an outer wall, parallel to the y-axis. The W in the ratio refers to the distance between the end burner and an end wall, such as an end wall parallel to the x-axis, as depicted in FIG. 3 or FIG. 6. However, in an embodiment, they may be substantially the same.

In an embodiment, the burners in the last row of the plurality of burners adjacent to a furnace wall and the first row adjacent to the furnace wall in the furnace are approximately equidistant from the respective walls that are parallel thereto. Moreover, in an embodiment, the burners in the first line perpendicular to the row of tubes and in the last line perpendicular to the row of tubes in each of the groupings are approximately equidistant from the respective walls that are perpendicular to the row of burners. But the distance from the walls parallel to the first and last row of burners (350, 360) with respect to the burners in the first row (312) and last row (360) may or may not be equal to the distance that the burners in the first and last line perpendicular to the aforementioned row of burners are from the walls (330, 340).

As described herein, neither B/G nor B/W can be 1.3.

In an embodiment of the present disclosure, B/G is greater than 1.5, and in another embodiment, it is greater than 1.7. In an embodiment, B/G ranges from about 1.5 to about 2.0, and in another embodiment, from about 1.7 to about 2.0, but cannot be 1.3.

Further, in an embodiment, B/W is less than 1.26. However, the value of B/W is always greater than 0. In an embodiment, B/W ranges from about 1.3 to about 1.0, excluding 1.3 and in another embodiment, from about 1.26 to about 1.0, but cannot be 1.3.

Further, in an embodiment, B/G ranges from about 1.3 to about 2.0, and B/W ranges from about 0 to about 1.3, and in another embodiment, B/G ranges from about 1.5 to about 2.3, and B/W ranges from about 1.0 to about 1.3, and in a further embodiment, B/G ranges from about 1.7 to about 2.0, and B/W ranges from about 1.0 to about 1.26.

In an embodiment, all of the burners used in each grouping have the same size or duty rating. Duty is the power rating of the burner (e.g., MMBTU/hr. or kW). Burners in adjacent rows can be different sizes. This is typical. For example, in an embodiment, outer rows will have lower duty burners than inner rows. However, within a given row, B/W<1.3 and B/G>1.3 for good heat distribution. However, there is no limitations to size variations across tube rows as this invention does not seek to prevent cross-row burner interactions.

In an embodiment, burners in each grouping are the same size. The “B” value, in an embodiment, is the same within a tube row. Moreover, in an embodiment, there can be different gap sizes “G” in a burner row. And for these different gap sizes, each B/G is calculated independently and each one is >1.3. Put another way, there will be two B/W per burner row (for each end of the row) and there can be multiple B/G. Each ratio must independently fit in the prescribed ranges. It is understood that all values of B/G and B/W fall within the prescribed values described in the present disclosure. It is also understood that these prescribed values are not average values of the B/G or B/W values.

Moreover, the injection properties of the burners adjacent to walls have substantially uniform injection properties relative to the burners not adjacent to walls in the same burner row, as long as the overall B/W is less than 1.3 and B/G is greater than 1.3. This ensures that the same burner size or duty can be utilized in the same row, simplifying furnace construction and maintenance. In an embodiment, the burners in adjacent rows are the same size. In another embodiment, at least one burner row has burners of a different size or duty rating but uniform within that row as long as the values each of B/W is less than 1.3 and of each B/G is greater than 1.3. Most advantageously, the same B/W and B/G values are used for every burner row to simplify construction. As long as the ratios for a given furnace are within the limitations described herein, the substantial merging of burner jets within burner groupings are minimized or substantially prevented, thus providing a more uniform heating of the reformer tubes from a single burner row can be achieved.

The burner spacing rules can be applied for cases where the tubes are loaded with different layering of catalyst since the flame interaction does not depend on the process gas environment, only the flue gas environment.

The burner spacing rules can be applied in cases where the tunnel ports have been modified to allow plug flow extraction of flue gases from the furnace.

The burner spacing rules can be applied for reformers that utilize Ni-based catalysts or reforming catalysts based on other metals (e.g., Ru).

The burner spacing rules can be applied for when the process is a steam reforming of hydrocarbons process, or a dry reforming of hydrocarbons process, such as, for example, a carbon dioxide methane dry forming process.

In an embodiment, there is no gap or burner grouping division line separating burners in the furnace. In other words, the furnace is set up so that there is a single burner grouping. However, the tubes are still separated into bays or “harps” for construction and installation. In such a situation, B/W must still be less than 1.3. However, since there is no gap, there is no B/G value. In other words, the burners are so arranged such that the distance between adjacent burner centerlines in the row of burners is about the same. This is similar to an embodiment having a B/G=2 where B=2G or where the distance between all burners in the tube row is substantially identical. Further, in an embodiment, B/W is less than 1.3 and, in another embodiment, is less than 1.26. However, B/W is always greater than 0. In an embodiment, B/W ranges from about 1.3 to about 1.0 and in another embodiment, from about 1.26 to about 1.0 but cannot be 1.3.

Burner jet interactions toward the center of the tube row, induced by the wall boundary condition on the burners at the ends of the burner rows, can be mitigated by keeping B/W<1.3. In an embodiment, in the gap-less reformers, the burner-burner spacing may be substantially uniform within the furnace and only B/W is modified to prevent burner jet flame interactions. Furnace designs that are gap-less in terms of burner spacing also tend to have substantially uniform spacing of the tubes, which leads to more uniform heating environment for the tubes in terms of radiative view factors.

Thus, an aspect of the present disclosure relates to a furnace for performing an endothermic process, the furnace comprises a first set of parallel furnace walls comprising a first end wall and a second end wall disposed opposite the first end wall, and a second set of parallel furnace walls perpendicular to the first set of parallel furnace walls, where the furnace further comprises: a plurality of groupings, wherein each grouping in the furnace is adjacent to each other and separated by a gap, wherein each gap separating each grouping has approximately uniform dimensions, wherein each grouping comprises:
(a) at least a first row of tubes comprising a plurality of tubes containing a catalyst for converting a gaseous feed, and optionally additional rows of tubes comprising a plurality of tubes parallel to the first row of tubes in each grouping and containing a catalyst for converting said gaseous feed;
(b) at least two rows of burners comprising a plurality of burners mounted in the at least two rows of burners, said at least two rows of burners having a first row of outer burners and a second row of outer burners and optionally additional rows of inner burners comprising a plurality of burners, wherein each row of burners is parallel to each other, and wherein each row of burners is parallel to the first row of tubes and any additional row or rows of tubes present, and wherein each row of tubes and each row of burners are parallel to the first set of parallel furnace walls and perpendicular to the second set of parallel furnace walls, such that the number of rows of tubes present is one less than the number of rows of burners present, wherein each row of tubes is adjacent to two rows of burners and wherein the first row of outer burners is adjacent to the first end wall and adjacent to the first row of tubes, and the second row of outer burners is adjacent to the second end wall, and to the last row of tubes, and each optionally inner row of burners present is adjacent to two rows of tubes; provided that when there is only one row of tubes, the last row of tubes is the same as the first row of tubes so that the last row of outer burners is adjacent to the second end wall and to the first row of tubes; and
(c) wherein the plurality of burners in each row within each grouping of the furnace are configured such that the ratio of B/G is greater than 1.3 and the ratio of B/W is less than 1.3, wherein B is the distance between adjacent burner centerlines in the rows of burners within each grouping, W is the distance between the furnace wall that is perpendicular to the rows of burners and the centerline of the adjacent burner in the rows of burners, and G is one half of the distance between burner centerlines in the rows of burners in adjacent groupings, and wherein each row of tubes is parallel to each row of burners in said grouping, wherein the plurality of groupings comprises a first and last grouping and each row of burners and each row of tubes in the first and last grouping are ended by the second set of parallel walls which are perpendicular to each row of tubes and each row of burners in the first and last grouping.

In another embodiment, there are no gaps present in the furnace. In this embodiment, the present disclosure relates to a furnace for performing an endothermic process, the furnace comprises a first set of parallel furnace walls comprising a first end wall and a second end wall disposed opposite the first end wall, and a second set of parallel furnace walls perpendicular to the first set of parallel furnace walls, wherein the furnace further comprises:
(a) at least a first row of tubes inside the furnace comprising a plurality of tubes containing a catalyst for converting a gaseous feed, and optionally additional rows of tubes comprising a plurality of tubes parallel to the first and last row of tubes in said furnace and containing a catalyst for converting said gaseous feed;
(b) at least two rows of burners inside the furnace comprising a plurality of burners mounted in the at least two rows of burners, said at least two rows of burners having a first row of outer burners and a second row of outer burners and optionally additional rows of inner burners comprising a plurality of burners, wherein each row of burners is parallel to each other, and wherein each row of burners is parallel to the first row of tubes and additional row or rows of tubes present, wherein each row of tubes and each row of burners are parallel to the first set of parallel furnace walls and perpendicular to the second set of parallel furnace walls, such that the number of rows of tubes present is one less than the number of rows of burners present and the first row of burners is adjacent to the first end wall and adjacent to the first row of tubes, and the second row of outer burners is adjacent to the second end wall, and to the last row of tubes and each optionally inner row of burners present is adjacent to two rows of tubes, provided that when there is only one row of tubes, the last row of tubes is the same as the first row of tubes so that the second row of outer burners is adjacent to the second end wall and to the first row of tubes;
(c) wherein each row of burners and each row of tubes in the furnace are ended by the second set of parallel walls which are perpendicular to each row of tubes and each row of burners, wherein the plurality of burners within the furnace are configured such that the ratio of B/W is less than 1.3, wherein B is the distance between adjacent burner centerlines in the rows of burners within the furnace, W is the distance between the furnace wall that is perpendicular to the rows of burners and the centerline of the adjacent burner in the rows of burners, and wherein each row of tubes is parallel to each row of burners in said furnace, wherein each row of tubes and each row of burners are ended by the second set of parallel walls which are perpendicular to each row of tubes and each row of burners in the furnace.

In another embodiment, there are multiple groupings of rows of tubes and burners, but there is only one row of tubes in the grouping and two rows of burners in each grouping, as depicted in FIG. 6.

In another embodiment, there are at least two rows of tubes comprising a plurality of tubes and three rows of burners comprising a plurality of burners in each row and there are a plurality of groupings in the furnace performing an endothermic process, the furnace comprises a first set of parallel furnace walls comprising a first end wall and a second end wall disposed opposite the first end wall, and a second set of parallel furnace walls perpendicular to the first set of parallel furnace walls, where the furnace further comprises: a plurality of groupings having a first and last grouping, wherein each grouping in the furnace is adjacent to another grouping and separated by a gap, wherein each grouping comprises:
(a) a plurality of rows of tubes containing a catalyst for converting a gaseous feed wherein the tubes are positioned in a plurality of rows inside the grouping, wherein the plurality of rows of tubes comprises a first row of tubes, a last row of tubes and optionally one or more inner rows of tubes disposed between the first row of tubes and the last row of tubes and wherein each row of tubes is parallel to one another;
(b) a plurality of burners in each grouping mounted in rows between each row of tubes and between the first set of furnace walls comprising a first row of outer burners and a second row of outer burners and one or more rows of inner burners, each row comprising a plurality of burners, wherein each row of burners is parallel to one another and wherein the first set of furnace walls are parallel to the rows of burners and tubes in each grouping and the second set of parallel furnace walls are perpendicular to the rows of burners and tubes in each grouping, such that the number of rows of tubes present is one less than the number of rows of burners present, wherein each row of tubes is adjacent to two rows of burners and wherein the first row of outer burners is adjacent to the first end wall and adjacent to the first row of tubes, and the second row of outer burners is adjacent to the second end wall and to the last row of tubes and each inner row of burners present is adjacent to two rows of tubes;
(c) wherein the plurality of burners within each grouping of the furnace are configured such that the ratio of B/G is greater than 1.3 and the ratio of B/W is less than 1.3, wherein B is the distance between adjacent burner centerlines in the rows of burners within each grouping, W is the distance between the furnace wall that is perpendicular to the rows of burners and the centerline of the adjacent burner in the row of burners, and G is one half of the distance between burner centerlines in the row of burners in adjacent groupings, and wherein each row of tubes is parallel to each row of burners in said grouping, wherein the plurality of groupings comprises a first and last grouping and each row of burners and each row of tubes in the first and last grouping are ended by the second set of parallel walls which are perpendicular to each row of tubes and each row of burners in the first and last grouping.

Another embodiment relates to a furnace for performing an endothermic process, wherein there are no gaps, and the furnace has only one row of tubes comprising a plurality of tubes and two rows of burners comprising a plurality of burners.

Another embodiment relates to a furnace for performing an endothermic process, wherein there are no gaps and there are at least two rows of tubes comprising a plurality of tubes and three rows of burners comprising a plurality of burners in each row and there are a plurality of groupings in the furnace performing the endothermic process, wherein the furnace comprises a first set of parallel furnace walls comprising a first end wall and a second end wall disposed opposite the first end wall, and a second set of parallel furnace walls perpendicular to the first set of parallel furnace walls, and wherein the furnace further comprises:
(a) a plurality of rows of tubes in the furnace containing a catalyst for converting a gaseous feed wherein the tubes are positioned in a plurality of rows inside the furnace, wherein the plurality of rows of tubes comprises a first row of tubes, a last row of tubes and optionally one or more inner rows of tubes disposed between the first row of tubes and the last row of tubes and wherein each row of tubes is parallel to one another;
(b) a plurality of burners in the furnace mounted in rows between each row of tubes and between the first set of furnace walls comprising a first row of outer burners and a second row of outer burners and one or more rows of inner burners, each row comprising a plurality of burners, wherein each row of burners is parallel to one another and wherein the first set of furnace walls are parallel to the rows of burners and tubes in the furnace and the second set of parallel furnace walls are perpendicular to the rows of burners and tubes in the furnace, such that the number of rows of tubes present is one less than the number of rows of burners present, wherein each row of tubes is adjacent to two rows of burners and wherein the first row of outer burners is adjacent to the first end wall and to the first row of tubes, and the second row of outer burners is adjacent to the second end wall and to the last row of tubes and each inner row of burners present is adjacent to two rows of tubes; and
(c) wherein the rows of burners and the rows of tubes are ended by the second set of furnace walls perpendicular to the row of burners and tubes, wherein the plurality of burners within the furnace are configured such that the ratio of B/W is less than 1.3; wherein B is the distance between adjacent burner centerlines in the row of burners within the furnace; W is the distance between the furnace wall that is perpendicular to the row of burners and the centerline of the adjacent burner in the row of burners, and wherein each row of tubes is parallel with each row of burners, and wherein each row of tubes and each row of burners are ended by the second set of parallel walls which are perpendicular to each row of tubes and each row of burners in the furnace

In an embodiment, the furnace is a methane reforming furnace. For example, in an embodiment, it is a steam methane reforming furnace or a carbon dioxide methane dry reforming furnace.

The furnace described herein is used for conducting steam reforming processes and other endothermic reactions such as hydrocarbon feedstock cracking in externally fired reactors. In an embodiment, such as in steam reforming, the feed materials as defined herein, for example, natural gas, liquid gas, or naphtha are endothermically converted with water steam into synthesis gas in catalytic tube reactors. Process heat as well as flue gas are used for the steam generation. In an embodiment, the feed is desulfurized prior to entering the furnace using techniques known in the art. The hydrocarbon feed is mixed with superheated process steam, which is generated in situ from the heat generated inside the furnace. Alternatively, water is introduced into the furnace either as steam or as a liquid which is then converted to steam in the furnace from the heat emanating from the burners in the furnace. After that, this gas mixture is heated up and then distributed on the catalyst-filled reformer tubes. In an embodiment, the gas mixture flows from top to bottom through tubes arranged in vertical rows. While flowing through the tubes heated from the outside, the hydrocarbon/steam mixture reacts, forming hydrogen and carbon monoxide. Since the reaction is endothermic, the required heat is produced by external firing. In an embodiment, the plurality of burners is mounted to the furnace roof and fire vertically downwards. In another embodiment, the plurality of burners is mounted to the floor of the furnace and fire vertically upwards.

Thus, in an embodiment, an endothermic process is performed in a furnace comprising tubes and burners, said process comprising:
(a) providing the furnace as described herein;
(b) providing a gaseous feed and steam in said furnace under conditions effective for converting the gaseous feed and steam into products; and
(c) discharging the products at an outlet end of the tubes.

Another aspect of the present disclosure relates to an endothermic process to be performed in a furnace comprising tubes and burners, said process comprising:
(a) providing the furnace as described herein;
(b) combusting fuel with air in the plurality of burners;
(c) introducing a gaseous feed and steam to the plurality of tubes under conditions effective for converting the gaseous feed and steam into products;
and (d) discharging the products at a lower end of the tubes.

The step of combusting fuel with air in the plurality of burners is for the purpose of initially firing up the jet flames of the burners inside the furnace. Any fuel known in the art can be used. Once the burners are generating the heat, the burners provide the necessary heat to effect the endothermic reaction performed in the burners. In an embodiment, the process is a methane reforming process. For example, it may be a steam methane reforming process or a carbon dioxide methane dry reforming process.

The present disclosure is applicable to top-fired, bottom-fired, side-fired, and terrace wall furnaces. In an embodiment, the burners are mounted to the furnace roof, and in another embodiment, the burners are mounted to the floor of the furnace and fire vertically upwards. In an embodiment, the furnace is a steam methane reforming furnace.

The present disclosure puts forward design rules that are applied to the arrangement of the burners all along the rows to obtain more regular tubes temperatures all along the rows. Thanks to the observance of these rules, hot tubes—frequently observed in the center or ends of the groupings—may be avoided; tube failures, replacement of tubes, and furnace shutdowns will therefore decrease.

The following non-limiting examples further illustrate the present invention.

### Example 1

In a top-fired furnace (400), jet flame burners (410) are set up so that there are three groupings of six burners each. The burners are arranged to be parallel to the top wall of the furnace from which the burners are mounted. B/W in the furnace is 1.26 and B/G is 1.8. This design for a single burner row is illustrated in FIG. 4. The temperature field of a single burner row is calculated via computational fluid dynamics (CFD) simulation. The temperature field is depicted in FIG. 4. As shown by the data in FIG. 4, there is no substantial burner jet merging within a burner grouping or between adjacent burner groupings, and the temperature profile is relatively uniform along the burner row.

In this example, the injection properties of the burners adjacent to walls have uniform injection properties relative to the burners not adjacent to walls in the same burner row where B/W=1.26 and B/G=1.8. This ensures that the same burner size or duty can be utilized, simplifying furnace construction. However, different burner sizes or duties can be used in adjacent burner rows following the same B/W=1.26 and B/G=1.8 guidelines to prevent flame interaction within the respective burner rows. For example, the outer burner rows of the furnace can be sized for 60-70% duty relative to the inner burner rows as long as B/W=1.26 and B/G=1.8 within each burner row.

### Comparative Example 1

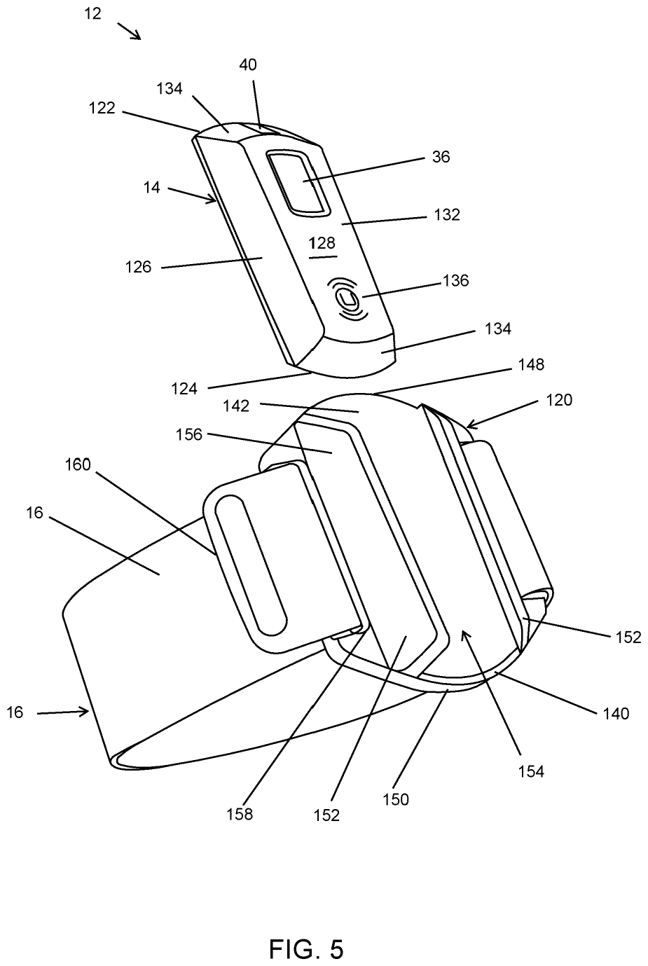

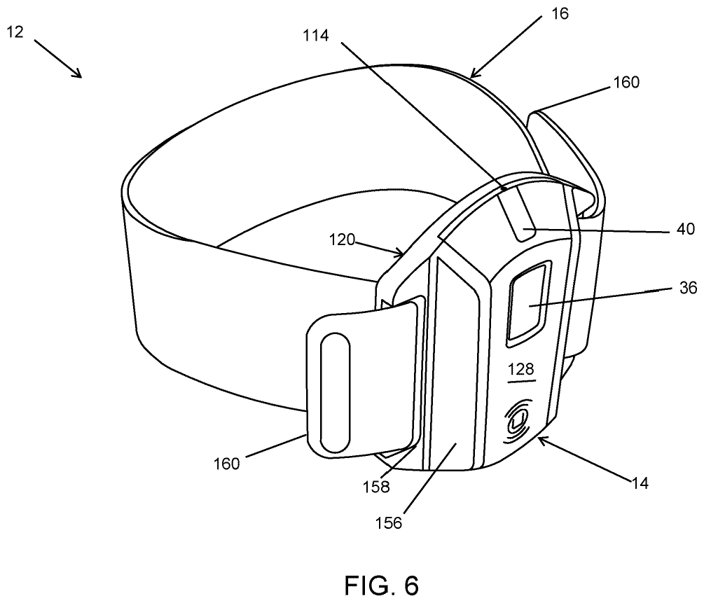

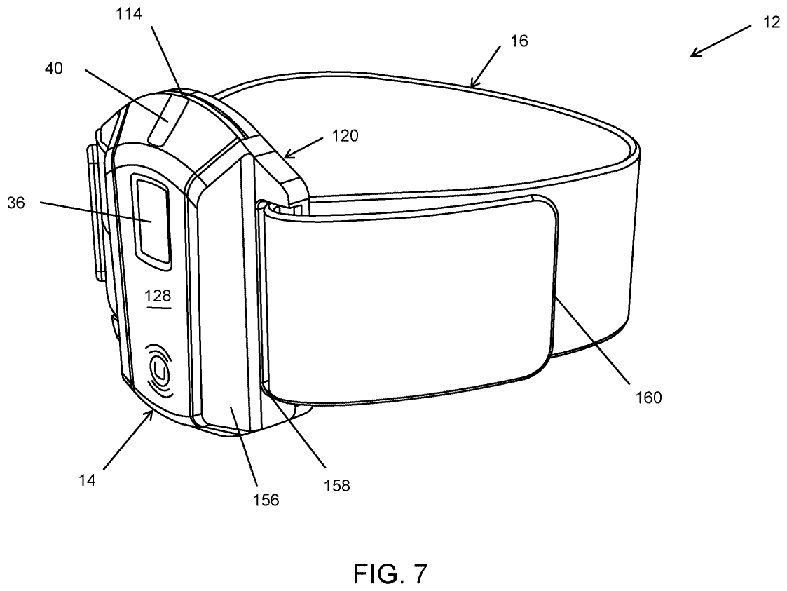

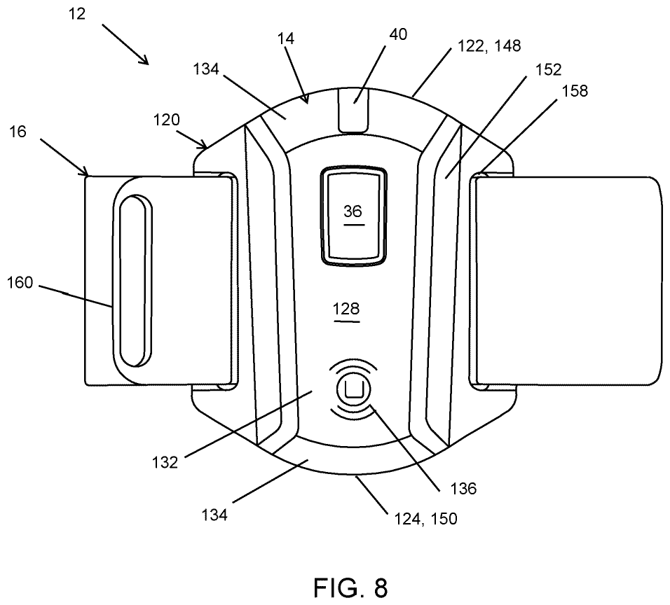

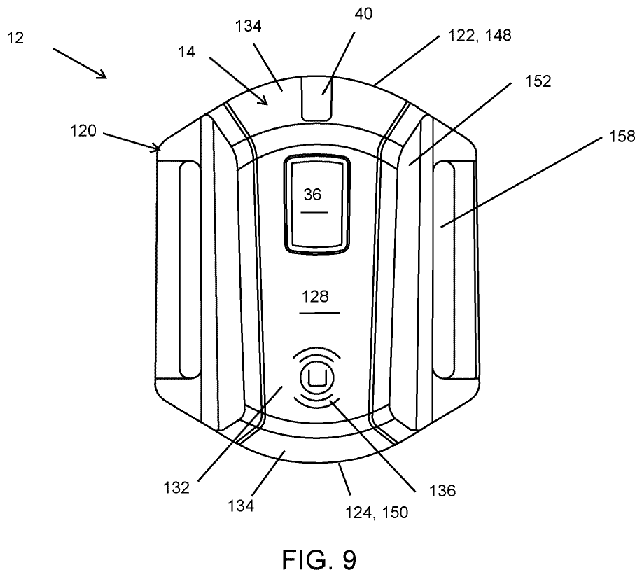

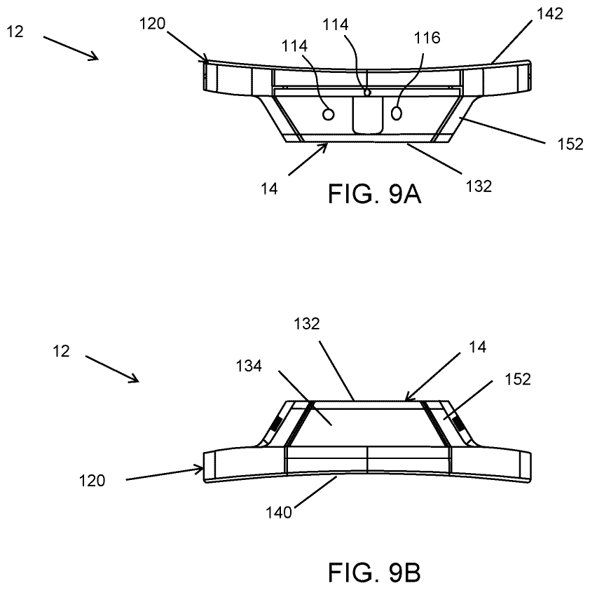

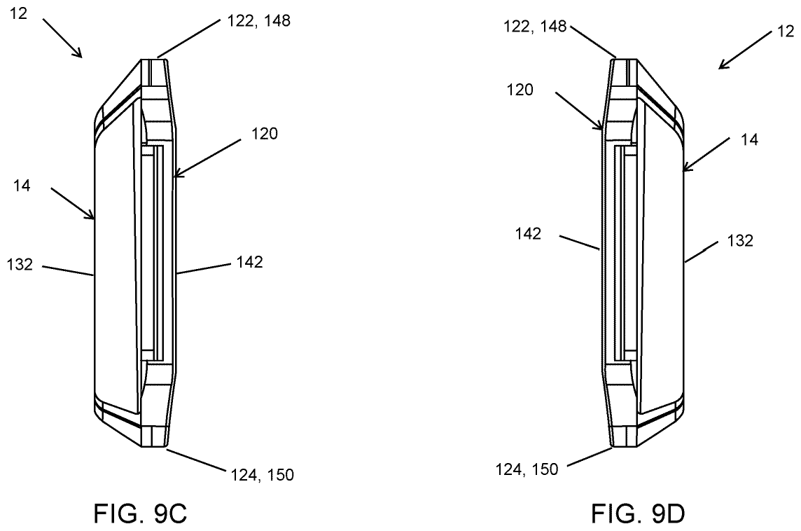

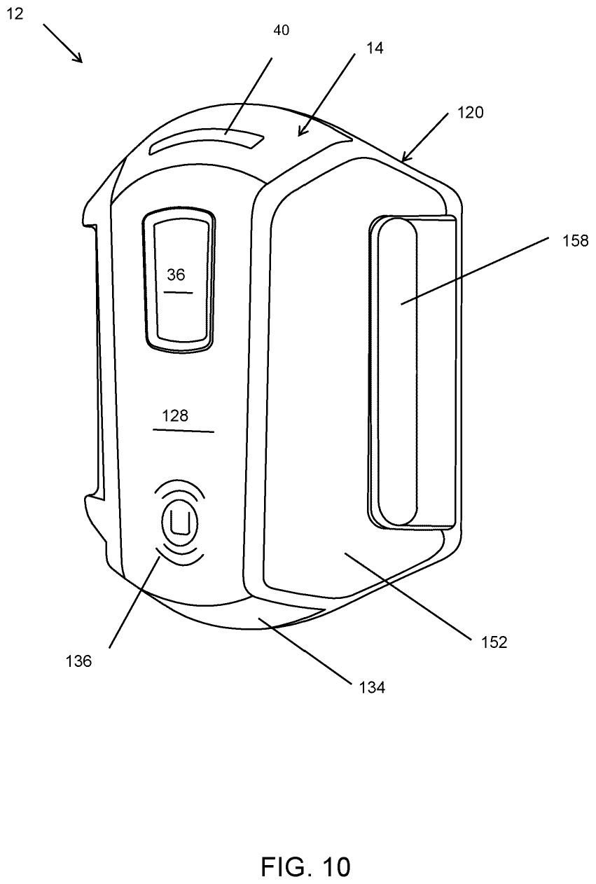

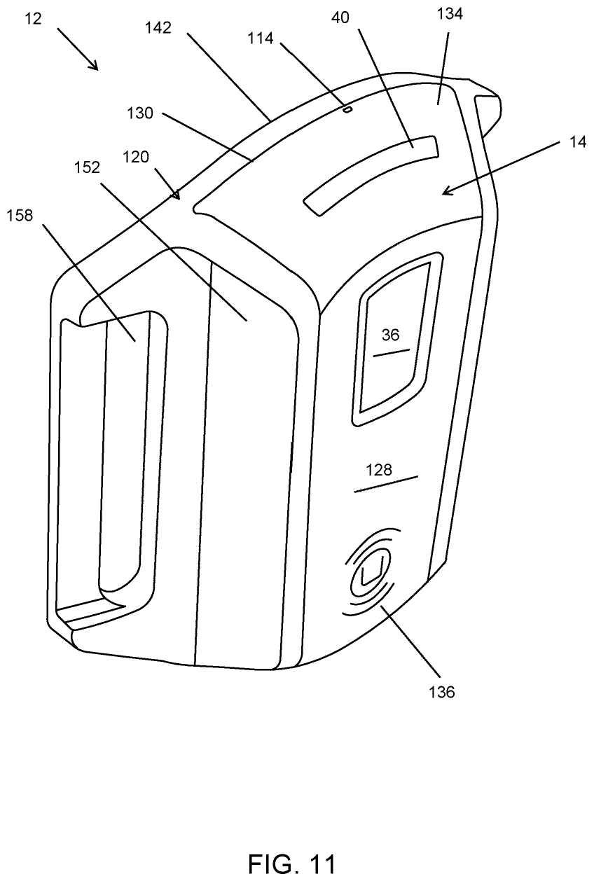

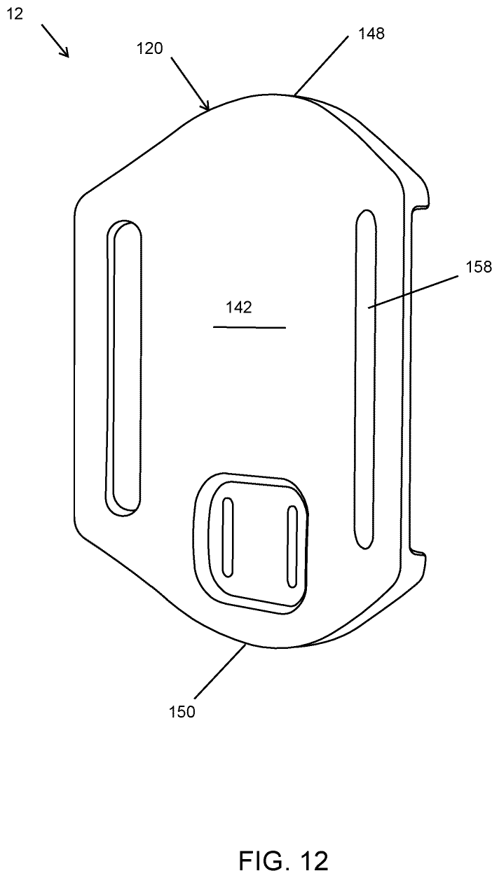

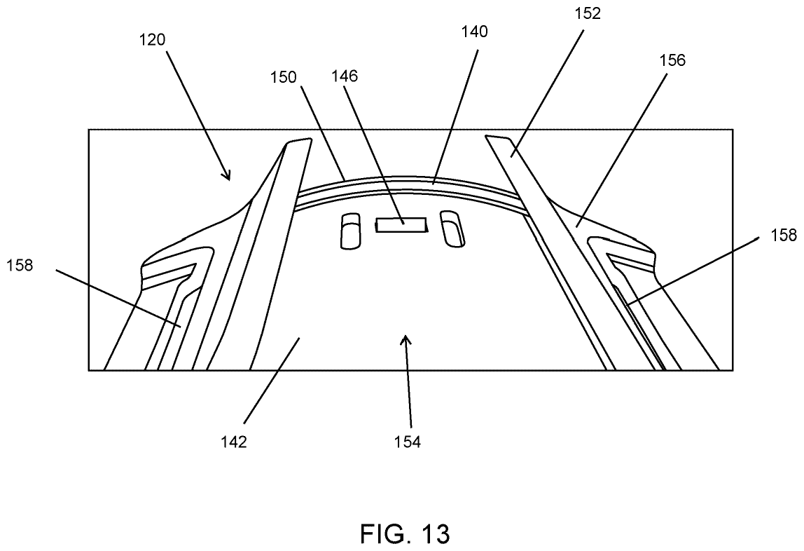

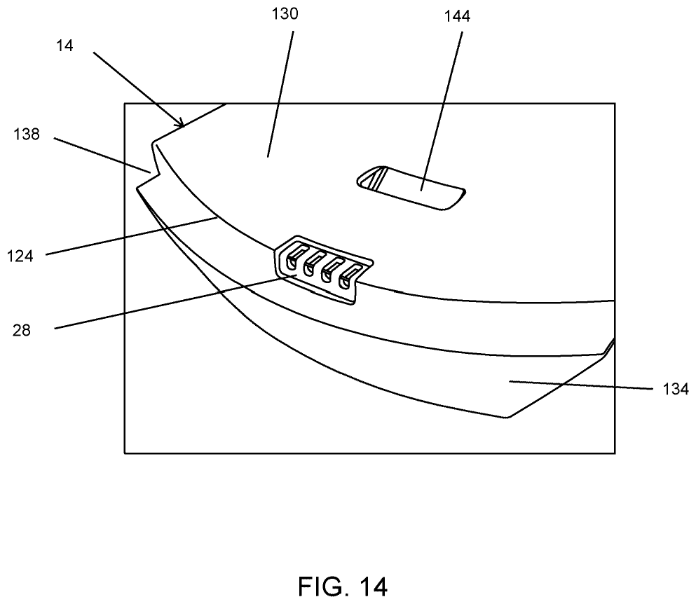

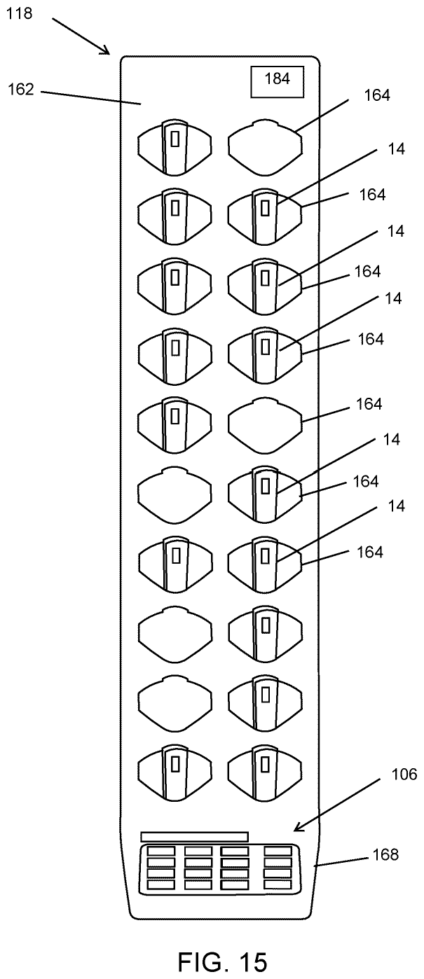

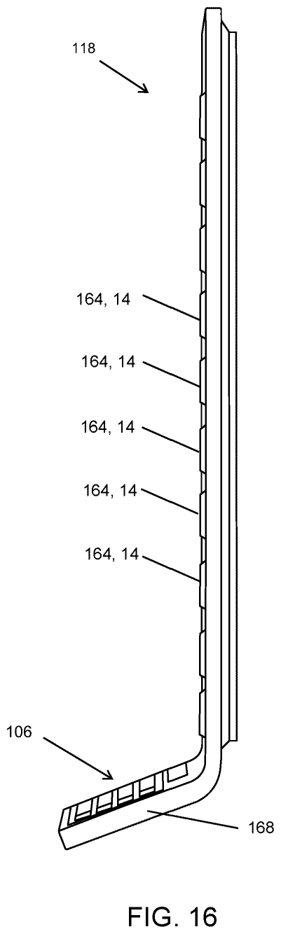

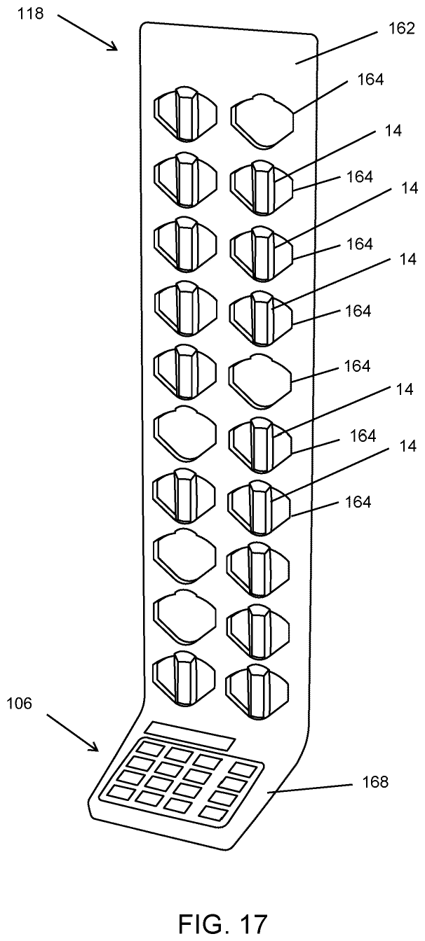

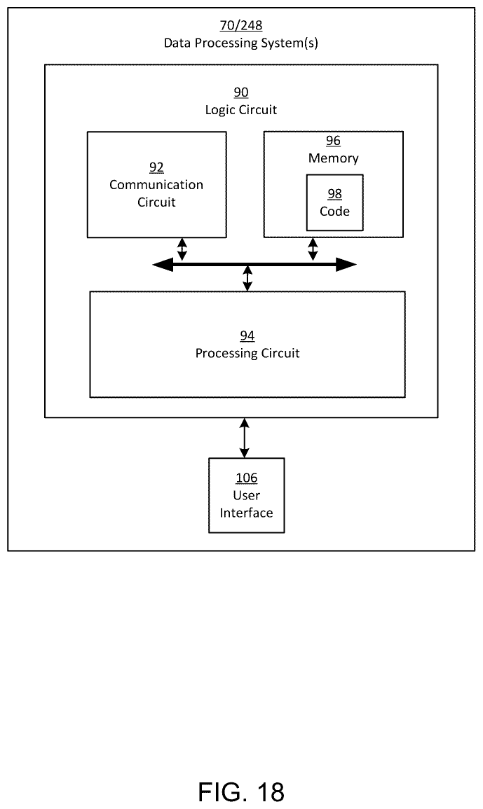

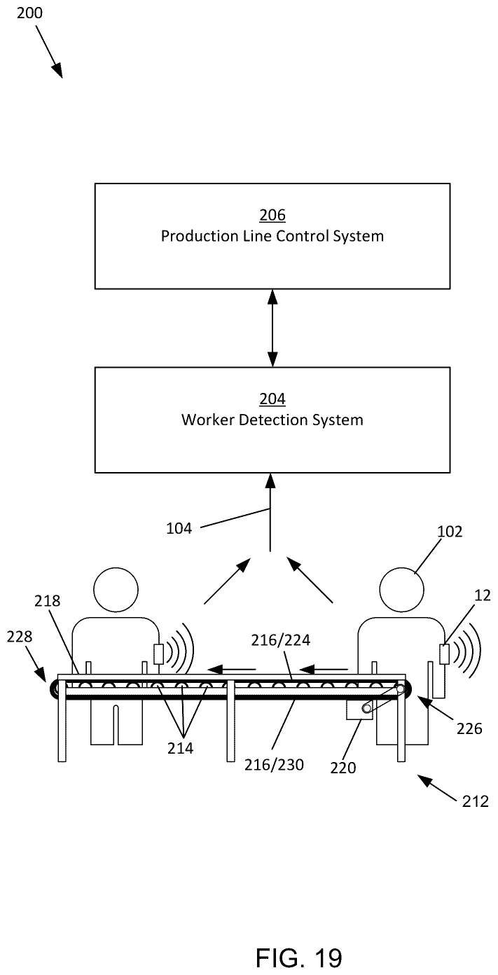

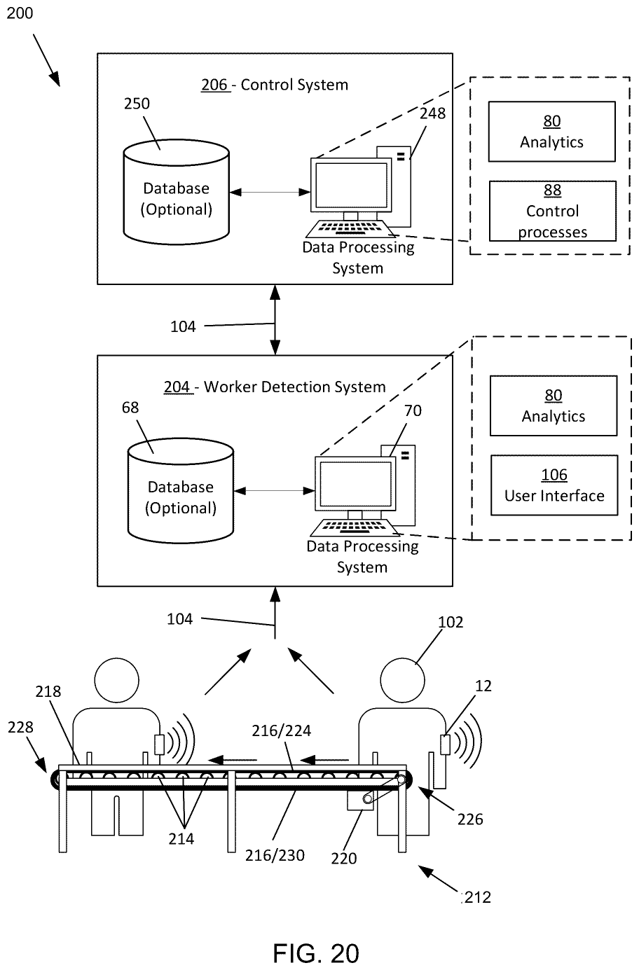

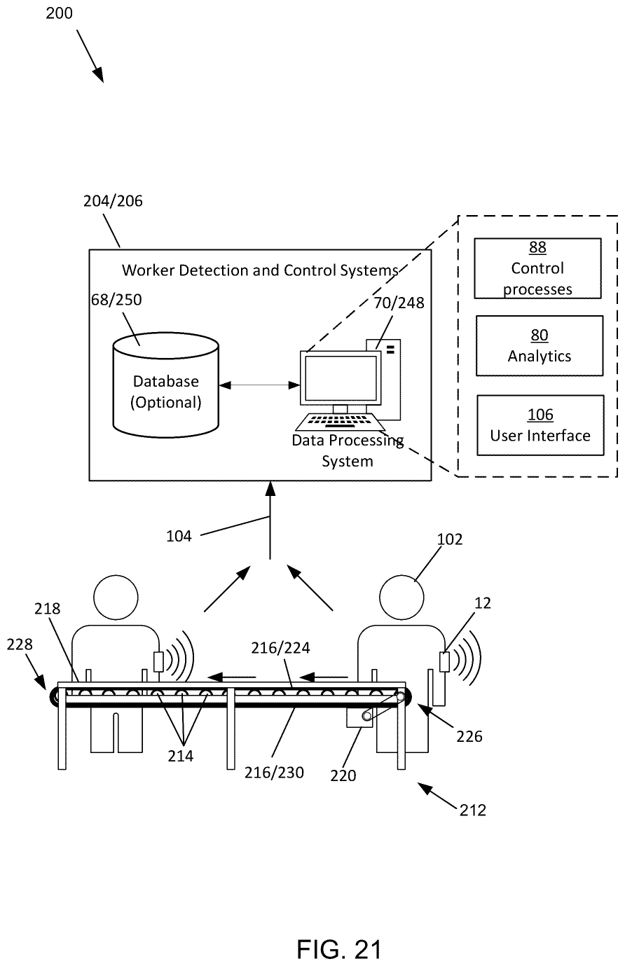

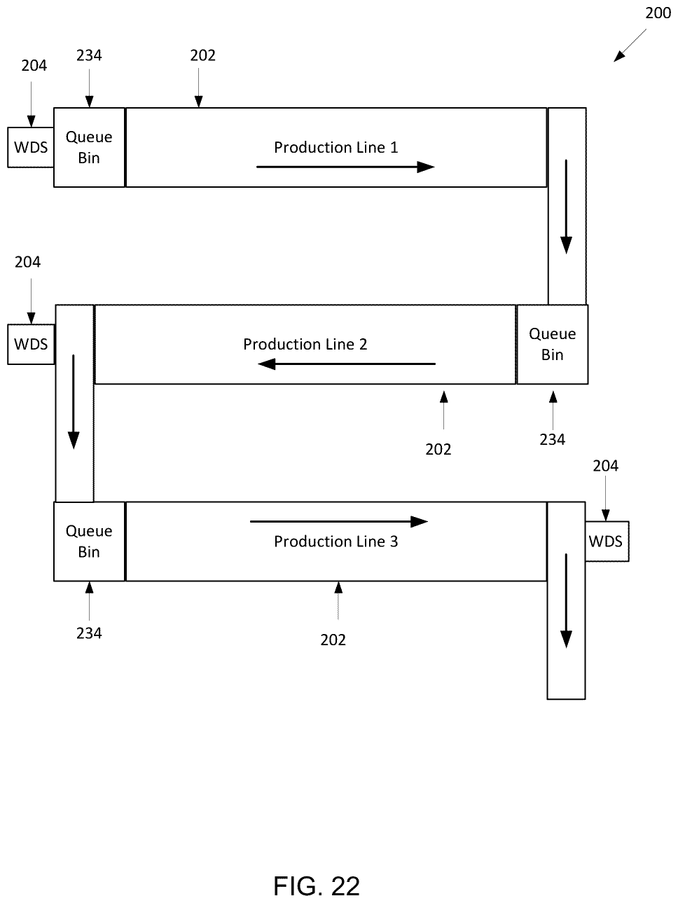

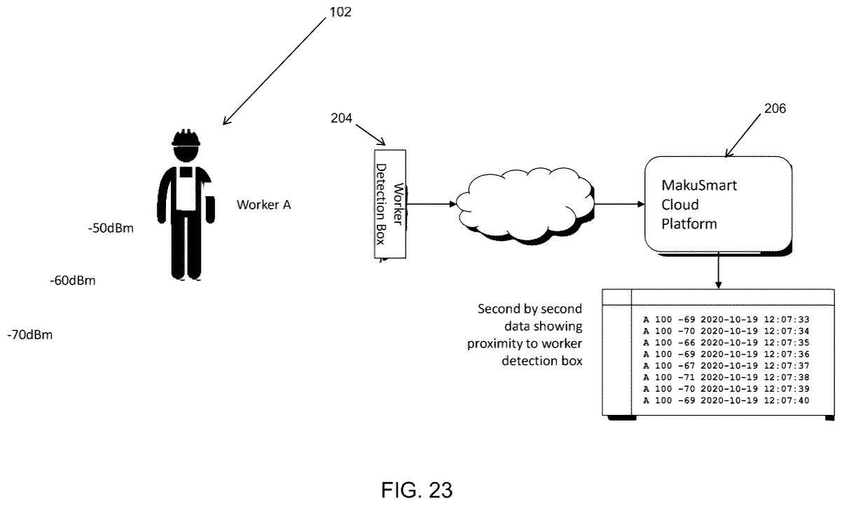

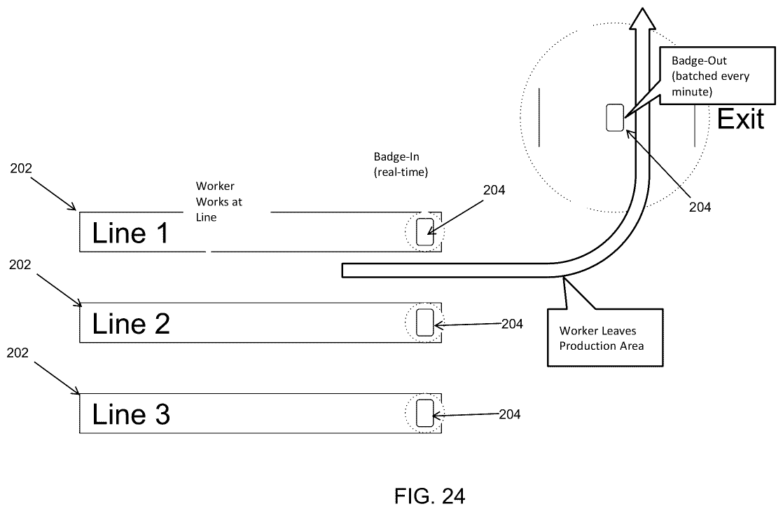

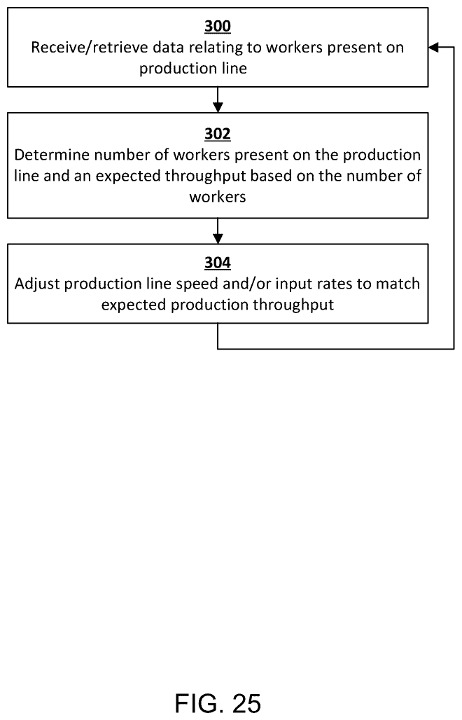

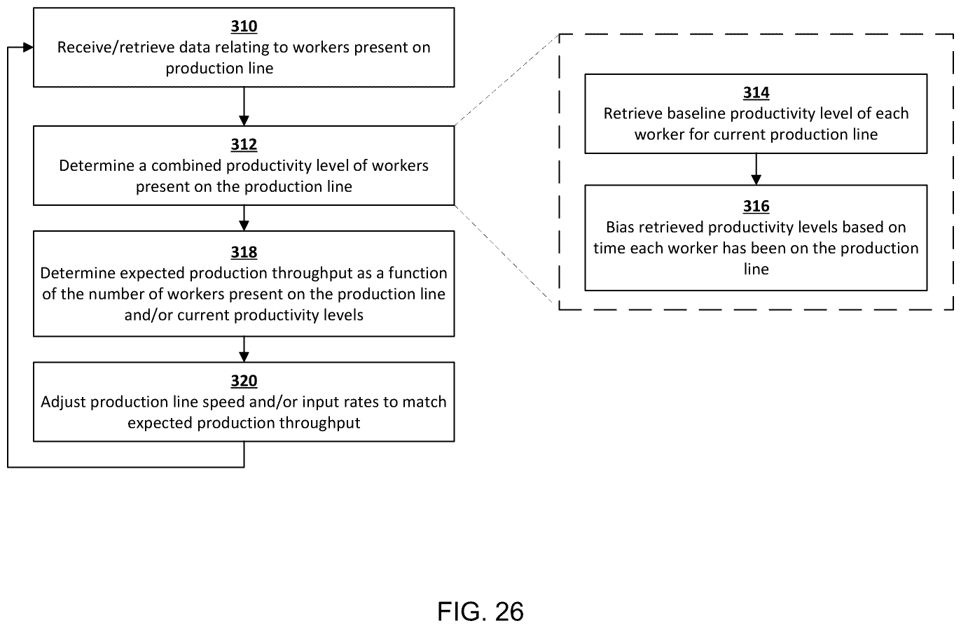

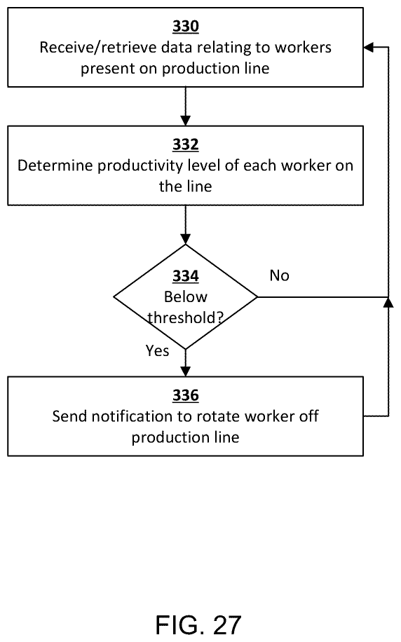

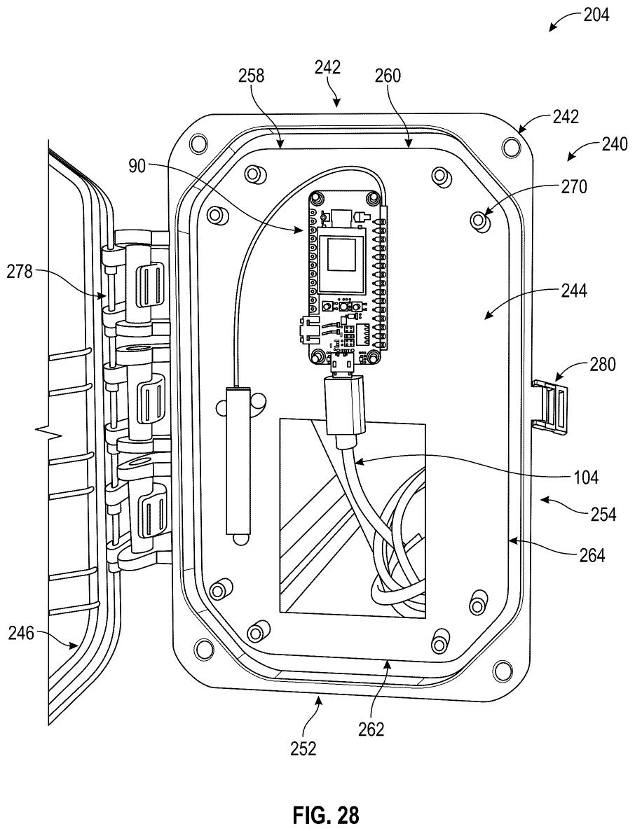

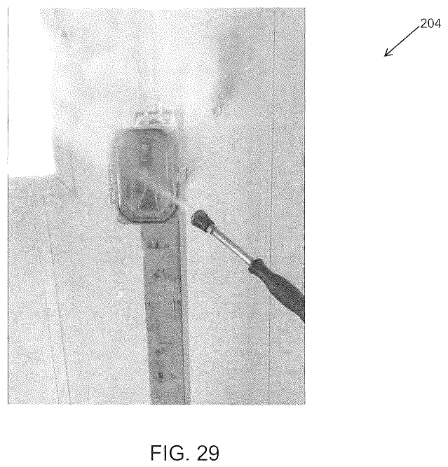

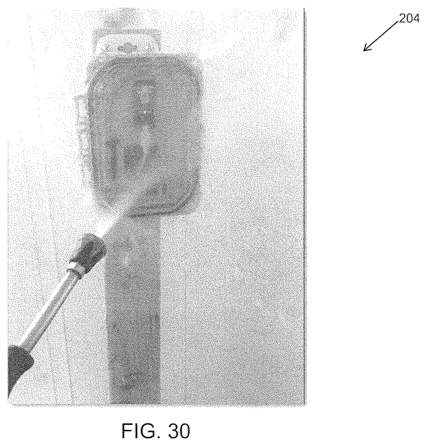

In a top-fired furnace (500), jet flame burners (510) are set up where so that there are three groupings of six burners each. In this top fired furnace, B/W is 1.18 and B/G is 1.14. This design for a single burner row centerline for a top-fired box reformer with jet burners is illustrated in FIG. 5. The temperature field of a single burner row is obtained via CFD simulation is depicted in FIG. 5. For this burner arrangement, the burner jets merge, generating a distribution of temperatures that leads to non-uniform heating of the reformer tubes along the tube row. The burner jets (510) at the ends of the burner rows lean away from the wall toward the center of the burner grouping, and burner jets adjacent to the gap also converge toward the center of the grouping. As a result, temperatures are locally higher at the center and lower at the edge of the tube grouping. In typical box reformers, this temperature spread can lead to unbalanced tube skin temperatures. Given that the operation of a box reformer is limited by the hottest skin temperatures up to the MAWT, the tubes located adjacent to where the burner jets merge are likely to limit production while tubes at the edges of the burner grouping may be underutilized.

Reformer tubes are the single largest capital cost in the reformer island followed by the catalyst. Reformer tubes can cost upwards of $20,000 each to install, and typical reformers have hundreds of tubes. In conventional designs where burner spacing is not adjusted to reduce the burner flame jets merging and tube heating non-uniformity, tube life can be substantially reduced where heat flux is higher than design. This can lead to pre-mature tube replacement and higher maintenance costs.

If reformer operation is curtailed to keep the hottest tubes at their design MAWT, but other tubes are operating at lower temperatures due to the non-uniformity of the heating, methane slip will be higher through the colder tubes, thus leading to overall less conversion in the reformer. If the process gas in half of the reformer tubes of a given top-fired reformer exits at 1572° F. with an average (max) skin temperature over the whole length of 1542° F. (1638° F.) and the process gas in the other half of the tubes exits 25° F. colder at 1547° F. with an average (max) skin temperature of 1521° F. (1614° F.), H2 production from the reformer drops 3.3%. This is due to the lower conversion of methane that can be achieved through steam reforming at lower temperatures. Thus, it is advantageous to operate all tubes as hot as designed. This can be achieved by adjusting the burner spacing to mitigate the burner flame jet merging along a burner row.[0103] The flame merging also can potentially cause jet impingement on tubes, which can lead to pre-mature tube failure and unexpected plant shutdown. The typical unexpected plant shutdown can cost as much as $1 MM.

Illustrative embodiments of the invention are described herein. While the invention is susceptible to various modifications and alternative forms, specific embodiments thereof have been shown by way of example in the drawings and are herein described in detail. It should be understood, however that the description herein of specific embodiments is not intended to limit the invention to the particular forms disclosed, but on the contrary, the invention is to cover all modifications, equivalents, and alternatives falling within the scope of the invention as defined by the appended claims.

What is claimed is:

1. A furnace for performing an endothermic process comprising a first set of parallel furnace walls comprising a first end wall and a second end wall disposed opposite the first end wall, and a second set of parallel furnace walls perpendicular to the first set of parallel furnace walls, where the furnace further comprises: a plurality of groupings, wherein each grouping in the furnace is adjacent to another grouping and separated by a gap, wherein each grouping comprises:
(a) at least a first row of tubes comprising a plurality of tubes containing a catalyst for converting a gaseous feed, and optionally additional rows of tubes comprising a plurality of tubes parallel to the first row of tubes in each grouping and containing a catalyst for converting said gaseous feed;
(b) at least two rows of burners comprising a plurality of burners mounted in the at least two rows of burners, said at least two rows of burners having a first row of outer burners and a second row of outer burners and optionally additional rows of inner burners comprising a plurality of burners, wherein each row of burners is parallel to each other, and wherein each row of burners is parallel to the first row of tubes and any additional row or rows of tubes that are present, wherein each row of tubes and each row of burners are parallel to the first set of parallel furnace walls and perpendicular to the second set of parallel furnace walls, such that the number of rows of tubes present is one less than the number of rows of burners present, wherein each row of tubes present is adjacent to two rows of burners and wherein the first row of outer burners is adjacent to the first end wall and adjacent to the first row of tubes, and the second row of outer burners is adjacent to the second end wall and to a last row of tubes, and each optionally inner row of burners present is adjacent to two rows of tubes present; provided that when there is only one row of tubes, the last row of tubes is the same as the first row of tubes so that the second row of outer burners is adjacent to the second end wall and to the first row of tubes;
(c) wherein the plurality of burners in each row within each grouping of the furnace are configured such that the ratio of B/G is greater than 1.3 and the ratio of B/W is less than 1.3, wherein B is the distance between adjacent burner centerlines in the rows of burners within each grouping, W is the distance between the furnace wall that is perpendicular to the rows of burners and the centerline of the adjacent burner in the rows of burners, and G is one half of the distance between burner centerlines in the rows of burners in adjacent groupings, and wherein each row of tubes is parallel to each row of burners in said grouping, wherein the plurality of groupings comprises a first and last grouping and each row of burners and each row of tubes in the first and last grouping are ended by the second set of parallel walls which are perpendicular to each row of tubes and each row of burners in the first and last grouping.

2. The furnace according to claim 1 comprising one row of tubes and two rows of burners.

3. The furnace according to claim 1 wherein each grouping comprises at least two rows of tubes and at least three rows of burners.

4. The furnace according to claim 1 wherein the ratio of B/G is greater than 1.5.

5. The furnace according to claim 1 wherein the ratio of B/G is greater than 1.7.

6. The furnace according to claim 1 wherein the ratio of B/G ranges from about 1.5 to about 2.0.

7. The furnace according to claim 1 wherein the ratio of B/G ranges from about 1.7 to about 2.0.

8. The furnace according to claim 1 wherein the plurality of burners is mounted to the furnace roof and fire vertically downwards.

9. The furnace according to claim 1 wherein the plurality of burners is mounted to the floor of the furnace and fire vertically upwards.

10. The furnace according to claim 1 wherein the furnace is a steam methane reforming furnace or a carbon dioxide methane reforming furnace.

11. The furnace according to claim 1 wherein the ratio B/W ranges from about 1.0 to 1.3 but excluding 1.3.

12. The furnace according to claim 1 wherein B/W ranges from about 1.0 to about 1.26 and B/G ranges from about 1.7 to about 2.0.

13. The furnace according to claim 1 wherein the number of tubes in each grouping of the furnace are substantially the same.

14. The furnace according to claim 1 wherein the types of burners within each grouping are the substantially the same.

15. The furnace according to claim 1 wherein the groupings in the furnace are substantially identical and the gaps between each of the groupings are substantially uniform.

16. A furnace for performing an endothermic process, the furnace comprises a first set of parallel furnace walls comprising a first end wall and a second end wall disposed opposite the first end wall, and a second set of parallel furnace walls perpendicular to the first set of parallel furnace walls, wherein the furnace further comprises:
(a) at least a first row of tubes comprising a plurality of tubes containing a catalyst for converting a gaseous feed, and optionally additional rows of tubes comprising a plurality of tubes parallel to the first row of tubes in said furnace and containing a catalyst for converting said gaseous feed,
(b) at least two rows of burners comprising a plurality of burners mounted in the at least two rows of burners, said at least two rows of burners having a first row of outer burners and a second row of outer burners and optionally additional rows of inner burners comprising a plurality of burners, wherein each row of burners is parallel to each other, and wherein each row of burners is parallel to the first row of tubes and parallel to any additional row or rows of tubes that are present, wherein each row of tubes and each row of burners are parallel to the first set of parallel furnace walls and perpendicular to the second set of parallel furnace walls, such that number of rows of tubes present is one less than the number of rows of burners present and the first row of burners is adjacent to the first end wall and adjacent to the first row of tubes, and the last row of outer burners is adjacent to the second end wall and to a last row of tubes and each optionally inner row of burners present is adjacent to two rows of tubes present, provided that when there is only one row of tubes, the last row of tubes is the same as the first row of tubes so that the second row of outer burners is adjacent to the second end wall and to the first row of tubes;
(c) wherein each row of burners and each row of tubes in the furnace are ended by the second set of parallel walls which are perpendicular to each row of tubes and each row of burners, and wherein the rows of burners and tubes are arranged in one grouping such that there ae no gaps within said furnace; wherein the plurality of burners within the furnace are configured such that the ratio of B/W is less than 1.3, wherein B is the distance between adjacent burner centerlines in the rows of burners within the furnace, W is the distance between the furnace wall that is perpendicular to the rows of burners and the centerline of the adjacent burner in the rows of burners, and wherein each row of tubes is parallel to each row of burners in said furnace, wherein each row of tubes and each row of burners are ended by the second set of parallel walls which are perpendicular to each row of tubes and each row of burners in the furnace.

17. The furnace according to claim 16 comprising one row of tubes and two rows of burners.

18. The furnace according to claim 16, wherein (a) comprises: a plurality of tubes containing a catalyst for converting a gaseous feed, wherein the tubes are positioned in a plurality of rows inside the furnace, wherein the plurality of rows of tubes comprises a first row of tubes, a last row of tubes and one or more inner rows of tubes disposed between the first row of tubes and the last row of tubes, (b) comprises a plurality of burners mounted in rows between each row of tubes and between the furnace walls; wherein each row of burners is parallel to one another; each row of tubes is parallel to each other and wherein the first set of furnace walls is parallel to the rows of burners and tubes in the furnace and the second set of parallel furnace walls is perpendicular to the rows of burners and tubes in the furnace; and wherein in (c) the rows of burners and the rows of tubes are ended at the second set of furnace walls perpendicular to the rows of burners and tubes, wherein the plurality of burners within the furnace are configured such that the ratio of B/W is less than 1.3 and all of the burners are substantially uniformly spaced apart in each row; wherein B is the distance between adjacent burner centerlines in the row of burners within the furnace; W is the distance between the furnace wall that is perpendicular to the row of burners and the centerline of the adjacent burner in the row of burners, and wherein each row of tubes is parallel with each row of burners.

19. The furnace according to claim 16 wherein the plurality of burners is mounted to the furnace roof and fire vertically downwards.

20. The furnace according to claim 16 wherein the plurality of burners is mounted to the floor of the furnace and fire vertically upwards.

21. The furnace according to claim 16 wherein the furnace is a steam methane reforming furnace or a carbon dioxide methane reforming furnace.

22. The furnace according to claim 16 wherein the ratio B/W ranges from about 1.0 to 1.3 but excluding 1.3.

23. The furnace according to claim 16 wherein B/W ranges from about 1.0 to about 1.26.

24. An endothermic process to be performed in a furnace comprising tubes and burners, said process comprising:
(a) providing the furnace as claimed in claim 1;
(b) introducing a gaseous feed and steam into said furnace under conditions effective for converting the gaseous feed and steam into products; and
(c) discharging the products at an outlet end of the tubes.

25. An endothermic process to be performed in a furnace comprising tubes and burners, said process comprising:
(a) providing the furnace as claimed in claim 16;
(b) introducing a gaseous feed and steam into said furnace under conditions effective for converting the gaseous feed and steam into products; and
(c) discharging the products at an outlet end of the tubes.

26. The process according to claim 24 wherein the process is steam reforming process or a carbon dioxide methane dry reforming process.

27. The process according to claim 25 wherein the process is steam reforming process or a carbon dioxide methane dry reforming process.
